(19) United States
(12) Patent Application Publication
(10) Pub. No.: US 2024/0422803 A1
(43) Pub. Date: Dec. 19, 2024

(54) MANAGING MULTICAST DATA TRANSMISSION AND RECEPTION IN A DISTRIBUTED BASE STATION ENVIRONMENT

(71) Applicant: GOOGLE LLC, Mountain View, CA (US)

(72) Inventor: Chih-Hsiang Wu, Taoyuan City (TW)

(21) Appl. No.: 18/702,562

(22) PCT Filed: Oct. 18, 2022
(86) PCT No.: PCT/US22/46938

§ 371 Date: Apr. 18, 2024

Related U.S. Application Data
(60) Provisional application No. 63/270,556, filed on Oct. 21, 2021.

(51) Int. Cl. H04W 72/30; H04W 76/40

(52) U.S. Cl. CPC H04W 72/30; H04W 76/40

(57) ABSTRACT

A method for managing transmission of multicast and/or broadcast services (MBS) is implemented in a central unit (CU) of a distributed base station that includes the CU and a distributed unit (DU). The method includes receiving, from a core network (CN), a request to configure CN-to-BS resources for transmitting downlink (DL) MBS data associated with an MBS session, from the CN for multiple user equipment units (UEs) via the distributed base station (602); obtaining a configuration for a downlink (DL) tunnel for transmitting the DL MBS data from the CU to the DU (606); and communicating the DL MBS data between the CN and the DU using the CN-to-BS resources and the configuration for the DL tunnel (614, 616).

### FIELD OF THE DISCLOSURE

This disclosure relates to wireless communications and, more particularly, to managing multicast and/or broadcast communications in a distributed base station environment.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP sublayer defined for the Evolved Universal Terrestrial Radio Access (EUTRA) radio interface (see Third Generation Partnership Project (3GPP) specification TS 36.323) and New Radio (NR) (see 3GPP specification TS 38.323) provides sequencing of protocol data units (PDUs) in the uplink direction from a user device (also known as a user equipment or “UE”) to a base station, as well as in the downlink direction from the base station to the UE. The PDCP sublayer also provides services for signaling radio bearers (SRBs) to the Radio Resource Control (RRC) sublayer. The PDCP sublayer further provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

The UE in some scenarios can concurrently utilize resources of multiple nodes (e.g., base stations or components of a distributed base station, also called a disaggregated base station) of a radio access network (RAN), interconnected by a backhaul. When these network nodes support different radio access technologies (RATs), this type of connectivity is referred to as multi-radio dual connectivity (MR-DC). When operating in MR-DC, the cell(s) associated with the base station operating as a master node (MN) define a master cell group (MCG), and the cells associated with the base station operating as a secondary node (SN) define the secondary cell group (SCG). The MCG covers a primary cell (PCell) and zero, one, or more secondary cells (SCells), and the SCG covers a primary secondary cell (PSCell) and zero, one, or more SCells. The UE communicates with the MN (via the MCG) and the SN (via the SCG). In other scenarios, the UE utilizes resources of one base station at a time, in single connectivity (SC). The UE in SC only communicates with the MN, via the MCG. A base station and/or the UE determines when the UE should establish a radio connection with another base station. For example, a base station can determine to hand the UE over to another base station, and initiate a handover procedure. The UE in other scenarios can concurrently utilize resources of another RAN node (e.g., a base station or a component of a distributed or disaggregated base station), interconnected by a backhaul.

UEs can use several types of SRBs and DRBs. So-called “SRB1” resources carry RRC messages, which in some cases include NAS messages over the dedicated control channel (DCCH), and “SRB2” resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and can also be referred to as MCG SRBs. “SRB3” resources allow the UE and the SN to exchange RRC messages related to the SN, and can also be referred to as SCG SRBs. Split SRBs allow the UE to exchange RRC messages directly with the MN via lower-layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MN or SN but using the lower-layer resources of both the MN and the SN can be referred to as split DRBs. DRBs terminated at the MN but using the lower-layer resources of only the SN can be referred to as MN-terminated SCG DRBs. DRBs terminated at the SN but using the lower-layer resources of only the MN can be referred to as SN-terminated MCG DRBs.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, user equipment units (UEs) support a 100 MHz bandwidth in frequency range 1 (FR1) and a 400 MHz bandwidth in frequency range (FR2). Due to the relatively wide bandwidth of a typical carrier in 5G NR, 3GPP has proposed for Release 17 that a 5G NR base station be able to provide multicast and/or broadcast service(s) (MBS) to UEs. MBS can be useful in many content delivery applications, such as transparent IPv4/IPv6 multicast delivery, IPTV, software delivery over wireless, group communications, Internet of Things (IoT) applications, V2X applications, and emergency messages related to public safety, for example.

5G NR provides both point-to-point (PTP) and point-to-multipoint (PTM) delivery methods for the transmission of MBS packet flows over the radio interface. In PTP communications, a RAN node transmits different copies of each MBS data packet to different UEs over the radio interface, while in PTM communications a RAN node transmits a single copy of each MBS data packet to multiple UEs over the radio interface. In some scenarios, however, it is unclear how a base station receives an MBS data packet from a core network and how the base station transmits each MBS data packet to UEs, particularly when the base station is implemented in a distributed manner.

### SUMMARY

One example embodiment of the techniques of this disclosure is a method for managing transmission of MBS, implemented in a CU of a distributed base station that includes the CU and a DU. The method is executed by processing hardware and includes receiving, from a core network (CN), a request to configure CN-to-BS resources for transmitting downlink (DL) MBS data associated with an MBS session, for multiple UEs via the distributed base station; obtaining a configuration for a downlink (DL) tunnel for transmitting the DL MBS data from the CU to the DU; and communicating the DL MBS data between the CN and the DU using the CN-to-BS resources and the configuration for the DL tunnel.

Another example embodiment of these techniques is a method for managing transmission of MBS data, implemented in a DU of a distributed base station that includes a CU and the DU. The method is executed by processing hardware and includes receiving, from the CU, a request for a configuration of a DL tunnel for receiving MBS data associated with an MBS session, for multiple UEs; transmitting, to the CU, the configuration of the DL tunnel; receiving the DL MBS data from the CU via the DL tunnel; and transmitting, via a radio interface, the DL MBS data to the multiple UEs.

Still another example embodiment of these techniques is a network node including processing hardware and configured to implement one of the methods above.

### BRIEF DESCRIPTION OF THE DRAWINGS

FIG. 1A is a block diagram of an example wireless communication system in which a Core Network (CN), a base station (BS), and a User Equipment (UE) can implement the techniques of this disclosure for managing Multicast and/or Broadcast Services (MBS) communications in a distributed base station environment;

FIG. 1B is a block diagram of an example base station (BS) including a central unit (CU) and a distributed unit (DU) that can operate in the system of FIG. 1A;

FIG. 2A is a block diagram of an example protocol stack according to which the UE of FIG. 1A can communicate with base stations of FIG. 1A;

FIG. 2B is a block diagram of an example protocol stack according to which the UE of FIG. 1A can communicate with a DU and a CU of a base station;

FIG. 2C is a block diagram of another example protocol stack according to which the UE of FIG. 1A can communicate with a DU and a CU of a base station, including support for F1AP protocol between the CU and DU;

FIG. 2D is a block diagram of an example protocol stack according to which a CU and a DU can communicate user-plane traffic;

FIG. 2E is a block diagram of an example protocol stack according to which a CU and a DU can communicate control-plane traffic;

FIG. 3 is a block diagram illustrating example tunnel architectures for MBS sessions and PDU sessions;

FIG. 4 is a block diagram illustrating example MRBs and DRBs which a distributed base station can configure for communicating multicast, broadcast, and/or unicast traffic with UEs;

FIG. 5A is a messaging diagram of an example scenario in which a CN and a distributed base station configure resources for transmitting MBS data of an MBS session to multiple UEs;

FIG. 5B is a messaging diagram of a scenario similar to that of FIG. 5A, but with the CN providing a list of UEs joining an MBS session prior to, rather than after, configuring a CN-to-BS tunnel for the MBS;

FIG. 6 is a flow diagram of an example method for configuring a CN-to-BS tunnel for receiving MBS data from a core network as well as a transport layer of the CU-to-DU link for transmitting the MBS data to the DU, and providing a radio interface configuration to a UE via the DU, which can be implemented in a CU of this disclosure;

FIG. 7 is a flow diagram of another method for configuring an MBS session at a CU, including multiple instances of a UE context setup procedure and multiple transmissions of the radio interface configuration to respective UEs;

FIG. 8 is a flow diagram of another method for configuring an MBS session at a CU, including configuring multiple CU-to-DU links for the respective DUs connected to the CU;

FIG. 9 is a flow diagram of a method for configuring an MBS session at a CU, including providing a common DU configuration to multiple UEs;

FIG. 10A is a flow diagram of an example method for configuring a transport layer of the CU-to-DU link for receiving MBS data from a CU, and generating DU configurations for UEs, which can be implemented in a DU of this disclosure;

FIG. 10B is a flow diagram of another example method for configuring an MBS session at a DU, but with the DU providing transport-layer configuration to the CU during the first UE context procedure, rather than separately and subsequently to establishing an MBS context;

FIG. 11 is a flow diagram of another method for configuring an MBS session at a DU, including multiple instances of a UE context setup procedure and multiple transmissions of the radio interface configuration to respective UEs;

FIG. 12 is a flow diagram of another method for configuring an MBS session at a DU, including configuring a DL tunnel on a CU-to-DU interface and a logical channel on a radio interface, for an MBS session;

FIG. 13 is a flow diagram of another method for configuring an MBS session at a DU, including configuring one or more QoS flows on a CU-to-DU interface and one or more corresponding logical channels on a radio interface, for the MBS session;

FIG. 14 is a flow diagram of an example method for determining uplink transport-layer configuration for a CU-to-DU link depending on whether the radio bearer is a DRB or an MRB, which can be implemented in a CU of this disclosure;

FIG. 15 is a flow diagram of an example method in a CU for determining whether to include an identity of one or more of an SRB, a DRB, or an MRB in a CU-to-DU message requesting radio resources for an MBS session or another data session;

FIG. 16 is a flow diagram of an example method in a DU for determining whether the CU requested one or more of an SRB, a DRB, or an MRB for an MBS session or another data session;

FIG. 17A is a flow diagram of an example method for DU for determining which logical channel the DU should use to transmit a data packet based on whether the DL tunnel via which the data packet arrived is associated with an MBS session or a UE-specific PDU session;

FIG. 17B is a flow diagram of an example method for DU for determining which logical channel the DU should use to transmit a data packet depending on whether the DL tunnel via which the data packet arrived is a common DL tunnel or a UE-specific DL tunnel;

FIG. 17C is a flow diagram of an example method for DU for determining which logical channel the DU should use to transmit a data packet depending on which DL tunnel the CU used to transmit the data packet;

FIG. 18 is a flow diagram of an example method in a DU for determining whether the DU should generate a transport layer configuration for an MBS session or include a previously generated transport configuration in a message to a CU;

FIG. 19 is a flow diagram of an example method for managing MBS transmissions, which can be implemented in a DU of this disclosure; and

FIG. 20 is a flow diagram of an example method for managing MBS transmissions, which can be implemented in a CU of this disclosure.

### DETAILED DESCRIPTION OF THE DRAWINGS

As discussed in more detail below, the nodes of a distributed base station of this disclosure manage MBS transmissions at the CU-to-DU interface as well as the radio interface between one or more DUs and multiple UEs that joined an MBS session. More specifically, the CU can configure a common DL tunnel on the CU-to-DU link, for transmitting MBS data packets received from a CN to the multiple UEs. The one or more DUs can configure logical channels (e.g., MTCHs, DTCHs) on the radio interface for the MBS session. The CU can further configure a multicast radio bearer (MRB) that includes a DL tunnel on the CU-to-DU link, optionally an UL tunnel on the CU-to-DU link, one or more DL logical channels, and optionally one or more uplink logical channels. Still further, the CU in some cases can configure multiple QoS flows of an MBS session, which the DU can map to respective different logical channels.

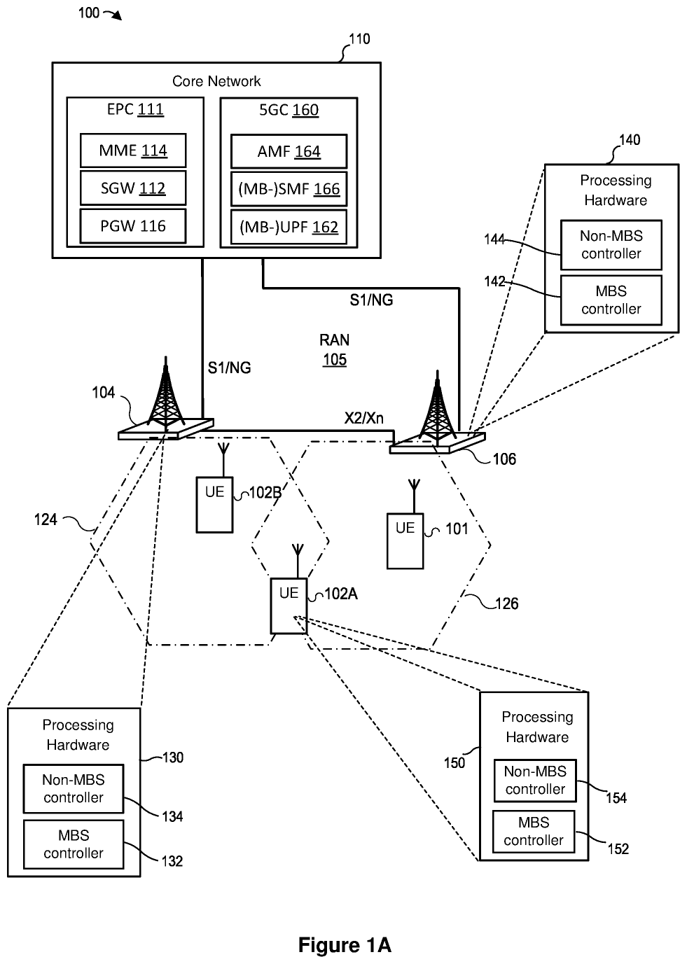

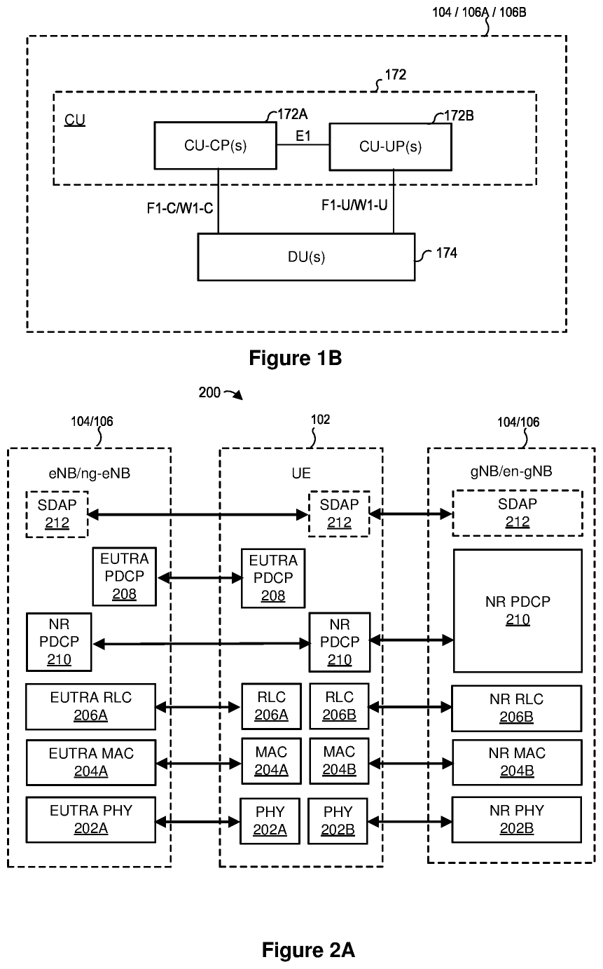

FIG. 1A depicts an example wireless communication system 100 in which techniques of this disclosure for managing transmission and reception of multicast and/or broadcast services (MBS) information can be implemented. The wireless communication system 100 includes user equipment (UEs) 102A, 102B, as well as base stations 104, 106 of a radio access network (RAN) 105 connected to a core network (CN) 110. In other implementations or scenarios, the wireless communication system 100 may instead include more or fewer UEs, and/or more or fewer base stations, than are shown in FIG. 1A. The base stations 104, 106 can be of any suitable type, or types, of base stations, such as an evolved node B (eNB), a next-generation eNB (ng-eNB), or a 5G Node B (gNB), for example. As a more specific example, the base station 104 may be an eNB or a gNB, and the base station 106 may be a gNB.

The base station 104 supports a cell 124, and the base station 106 supports a cell 126. The cell 124 partially overlaps with the cell 126, so that the UE 102A can be in range to communicate with base station 104 while simultaneously being in range to communicate with the base station 106 (or in range to detect or measure signals from the base station 106). The overlap can make it possible for the UE 102A to hand over between the cells (e.g., from the cell 124 to the cell 126) or base stations (e.g., from the base station 104 to the base station 106) before the UE 102A experiences radio link failure, for example. Moreover, the overlap allows the various dual connectivity (DC) scenarios. For example, the UE 102A can communicate in DC with the base station 104 (operating as a master node (MN)) and the base station 106 (operating as a secondary node (SN)). When the UE 102A is in DC with the base station 104 and the base station 106, the base station 104 operates as a master eNB (MeNB), a master ng-eNB (Mng-eNB), or a master gNB (MgNB), and the base station 106 operates as a secondary gNB (SgNB) or a secondary ng-eNB (Sng-eNB).

In non-MBS (unicast) operation, the UE 102A can use a radio bearer (e.g., a DRB or an SRB)) that at different times terminates at an MN (e.g., the base station 104) or an SN (e.g., the base station 106). For example, after handover or SN change to the base station 106, the UE 102A can use a radio bearer (e.g., a DRB or an SRB) that terminates at the base station 106. The UE 102A can apply one or more security keys when communicating on the radio bearer, in the uplink (from the UE 102A to a base station) and/or downlink (from a base station to the UE 102A) direction. In non-MBS operation, the UE 102A transmits data via the radio bearer on (i.e., within) an uplink (UL) bandwidth part (BWP) of a cell to the base station, and/or receives data via the radio bearer on a downlink (DL) BWP of the cell from the base station. The UL BWP can be an initial UL BWP or a dedicated UL BWP, and the DL BWP can be an initial DL BWP or a dedicated DL BWP. The UE 102A can receive paging, system information, public warning message(s), or a random access response on the DL BWP. In this non-MBS operation, the UE 102A can be in a connected state. Alternatively, the UE 102A can be in an idle or inactive state if the UE 102A supports small data transmission in the idle or inactive state.

In MBS operation, the UE 102A can use an MBS radio bearer (MRB) that at different times terminates at an MN (e.g., the base station 104) or an SN (e.g., the base station 106). For example, after handover or SN change, the UE 102A can use an MRB that terminates at the base station 106, which can be operating as an MN or SN. In some scenarios, a base station (e.g., the MN or SN) can transmit MBS data over unicast radio resources (i.e., the radio resources dedicated to the UE 102A) to the UE 102A via the MRB. In other scenarios, the base station (e.g., the MN or SN) can transmit MBS data over multicast radio resources (i.e., the radio resources common to the UE 102A and one or more other UEs), or a DL BWP of a cell from the base station to the UE 102A via the MRB. The DL BWP can be an initial DL BWP, a dedicated DL BWP, or an MBS DL BWP (i.e., a DL BWP that is specific to MBS, or not for unicast).

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation of FIG. 1A includes an MBS controller 132 that is configured to manage or control transmission of MBS information received from the CN 110 or an edge server. For example, the MBS controller 132 can be configured to support radio resource control (RRC) configurations, procedures and messaging associated with MBS procedures, and/or other operations associated with those configurations and/or procedures, as discussed below. The processing hardware 130 can also include a non-MBS controller 134 that is configured to manage or control one or more RRC configurations and/or RRC procedures when the base station 104 operates as an MN or SN during a non-MBS operation.

The base station 106 includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes an MBS controller 142 and a non-MBS controller 144, which may be similar to the controllers 132 and 134, respectively, of base station 130. Although not shown in FIG. 1A, the RAN 105 can include additional base stations with processing hardware similar to the processing hardware 130 of the base station 104 and/or the processing hardware 140 of the base station 106.

The UE 102A includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes an MBS controller 152 that is configured to manage or control reception of MBS information. For example, the UE MBS controller 152 can be configured to support RRC configurations, procedures and messaging associated with MBS procedures, and/or other operations associated with those configurations and/or procedures, as discussed below. The processing hardware 150 can also include a non-MBS controller 154 configured to manage or control one or more RRC configurations and/or RRC procedures in accordance with any of the implementations discussed below, when the UE 102A communicates with an MN and/or an SN during a non-MBS operation. Although not shown in FIG. 1A, the UE 102B may include processing hardware similar to the processing hardware 150 of the UE 102A.

The CN 110 may be an evolved packet core (EPC) 111 or a fifth-generation core (5GC) 160, both of which are depicted in FIG. 1A. The base station 104 may be an eNB supporting an SI interface for communicating with the EPC 111, an ng-eNB supporting an NG interface for communicating with the 5GC 160, or a gNB that supports an NR radio interface as well as an NG interface for communicating with the 5GC 160. The base station 106 may be an EUTRA-NR DC (EN-DC) gNB (en-gNB) with an SI interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104 and 106 may support an X2 or Xn interface.

Among other components, the EPC 111 can include a serving gateway (SGW) 112, a mobility management entity (MME) 114, and a packet data network gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from a UE (e.g., UE 102A or 102B) to one or more external packet data networks, e.g., an Internet network and/or an Internet Protocol (IP) Multimedia Subsystem (IMS) network. The 5GC 160 can include a user plane function (UPF) 162 and an access and mobility management function (AMF) 164, and/or a session management function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

The UPF 162, AMF 164, and/or SMF 166 can be configured to support MBS. For example, the SMF 166 can be configured to manage or control MBS transport, configure the UPF 162 and/or RAN 105 for MBS flows, and/or manage or configure one or more MBS sessions or PDU sessions for MBS for a UE (e.g., UE 102A or 102B). The UPF 162 is configured to transfer MBS data packets to audio, video, Internet traffic, etc. to the RAN 105. The UPF 162 and/or SMF 166 can be configured for both non-MBS unicast services and MBS services, or for MBS services only, as denoted by the prefix “(MB-)” shown in FIG. 1A.

Generally, the wireless communication system 100 may include any suitable number of base stations supporting NR cells and/or EUTRA cells. More particularly, the EPC 111 or the 5GC 160 may be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies, such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, and the base station 106 can operate as an SgNB or an Sng-eNB. The UE 102A can communicate with the base station 104 and the base station 106 via the same radio access technology (RAT), such as EUTRA or NR, or via different RATs.

When the base station 104 is an MeNB and the base station 106 is an SgNB, the UE 102A can be in EN-DC with the MeNB 104 and the SgNB 106. When the base station 104 is an Mng-eNB and the base station 106 is an SgNB, the UE 102A can be in next generation (NG) EUTRA-NR DC (NGEN-DC) with the Mng-eNB 104 and the SgNB 106. When the base station 104 is an MgNB and the base station 106 is an SgNB, the UE 102A can be in NR-NR DC (NR-DC) with the MgNB 104 and the SgNB 106. When the base station 104 is an MgNB and the base station 106 is an Sng-eNB, the UE 102A can be in NR-EUTRA DC (NE-DC) with the MgNB 104 and the Sng-eNB 106.

FIG. 1B depicts an example distributed implementation of any one or more of the base stations 104 and 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include some or all of the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 104) operates as an MN or an SN. The processing hardware can also include a physical (PHY) layer controller configured to manage or control one or more PHY layer operations or procedures.

In some implementations, the CU 172 can include one or more logical nodes (CU-CP(s) 172A) that host the control plane part of the Packet Data Convergence Protocol (PDCP) protocol of the CU 172 and/or the radio resource control (RRC) protocol of the CU 172. The CU 172 can also include one or more logical nodes (CU-UP(s) 172B) that host the user plane part of the PDCP protocol and/or service data adaptation protocol (SDAP) protocol of the CU 172. The CU-CP(s) 172A can transmit non-MBS control information and MBS control information, and the CU-UP(s) 172B can transmit non-MBS data packets and MBS data packets, as described herein.

The CU-CP(s) 172A can be connected to multiple CU-UPs 172B through the E1 interface. The CU-CP(s) 172A select the appropriate CU-UP(s) 172B for the requested services for the UE 102A. In some implementations, a single CU-UP 172B can be connected to multiple CU-CPs 172A through the E1 interface. A CU-CP 172A can be connected to one or more DUs 174s through an F1-C interface. A CU-UP 172B can be connected to one or more DUs 174 through an F1-U interface under the control of the same CU-CP 172A. In some implementations, one DU 174 can be connected to multiple CU-UPs 172B under the control of the same CU-CP 172A. In such implementations, the connectivity between a CU-UP 172B and a DU 174 is established by the CU-CP 172A using bearer context management functions.

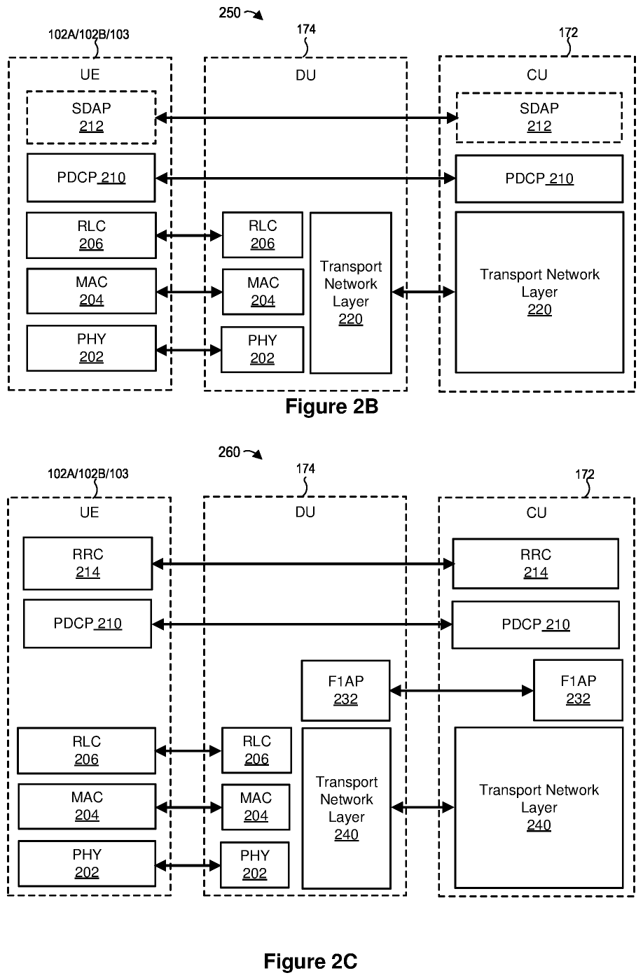

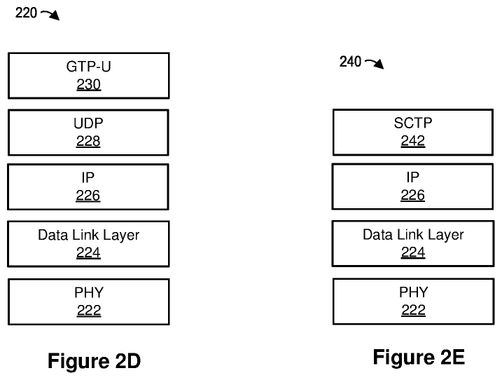

FIG. 2A illustrates, in a simplified manner, an example protocol stack 200 according to which a UE (e.g., UE 102A or 102B) can communicate with an eNB/ng-eNB or a gNB (e.g., one or more of the base stations 104, 106). In the example protocol stack 200, a PHY sublayer 202A of EUTRA provides transport channels to an EUTRA MAC sublayer 204A, which in turn provides logical channels to an EUTRA RLC sublayer 206A. The EUTRA RLC sublayer 206A in turn provides RLC channels to an EUTRA PDCP sublayer 208 and, in some cases, to an NR PDCP sublayer 210. Similarly, an NR PHY 202B provides transport channels to an NR MAC sublayer 204B, which in turn provides logical channels to an NR RLC sublayer 206B. The NR RLC sublayer 206B in turn provides RLC channels to an NR PDCP sublayer 210. The UE 102A or 102B, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102A or 102B can support layering of NR PDCP 210 over EUTRA RLC 206A, and an SDAP sublayer 212 over the NR PDCP sublayer 210. Sublayers are also referred to herein as simply “layers.”

The EUTRA PDCP sublayer 208 and the NR PDCP sublayer 210 receive packets (e.g., from an IP layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.” The packets can be MBS packets or non-MBS packets. MBS packets may include application content for an MBS service (e.g., IPv4/IPv6 multicast delivery, IPTV, software delivery over wireless, group communications, IoT applications, V2X applications, and/or emergency messages related to public safety), for example. As another example, MBS packets may include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 may be SDAP PDUs, IP packets, or Ethernet packets, for example.

In scenarios where the UE 102A or 102B operates in EN-DC with the base station 104 operating as an MeNB and the base station 106 operating as an SgNB, the wireless communication system 100 can provide the UE 102A or 102B with an MN-terminated bearer that uses EUTRA PDCP sublayer 208, or an MN-terminated bearer that uses NR PDCP sublayer 210. The wireless communication system 100 in various scenarios can also provide the UE 102A or 102B with an SN-terminated bearer, which uses only the NR PDCP sublayer 210. The MN-terminated bearer may be an MCG bearer, a split bearer, or an MN-terminated SCG bearer. The SN-terminated bearer may be an SCG bearer, a split bearer, or an SN-terminated MCG bearer. The MN-terminated bearer may be an SRB (e.g., SRB1 or SRB2) or a DRB. The SN-terminated bearer may be an SRB or a DRB.

In some implementations, a base station (e.g., base station 104, 106) broadcasts MBS data packets via one or more MBS radio bearers (MRB(s)), and in turn the UE 102A or 102B receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE 102A or 102B uses PHY sublayer 202, MAC sublayer 204, and RLC sublayer 206 to receive the MBS data packets. In such implementations, the base station and the UE 102A or 102B may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE 102A of 102B uses PHY sublayer 202, MAC sublayer 204, RLC sublayer 206 and PDCP sublayer 208 to receive the MBS data packets. In such implementations, the base station and the UE 102A or 102B may not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204, and PHY sublayer 202 and, correspondingly, the UE 102A or 102B uses the PHY sublayer 202, MAC sublayer 204, RLC sublayer 206, PDCP sublayer 208, and SDAP sublayer 212 to receive the MBS data packets.

FIG. 2B illustrates, in a simplified manner, an example protocol stack 250 which the UE 102A or 102B can use to communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

FIG. 2C illustrates, in a simplified manner, an example protocol stack 260 which the UE 102A or 102B can use to communicate with a DU (e.g., DU 174) and a CU (e.g., CU 172). The protocol stack 260 is generally similar to the protocol stack 250, but here the RRC layer 214 is layered over the PDCP layer 210 to convey RRC messages between a UE and the CU 172, transparently to the DU 174.

FIG. 2D is a block diagram of an example protocol stack 270 according to which the CU 172 and a DU 174 can communicate user-plane traffic. A GTP-U layer 278 is layered over UDP 276, in turn layered over IP 274. The UDP/IP layers reside over a data link layer 272 and a PHY 271 layer. The PHY layer 271 can be a wired link, for example.

FIG. 2E is a block diagram of an example protocol stack 280 according to the CU 172 and a DU 174 can communicate control-plane traffic. The stack 280 is generally similar to the stack 270, but here a Stream Control Transmission Protocol (SCTP) layer 282 resides over the IP layer 274 to convey control messages.

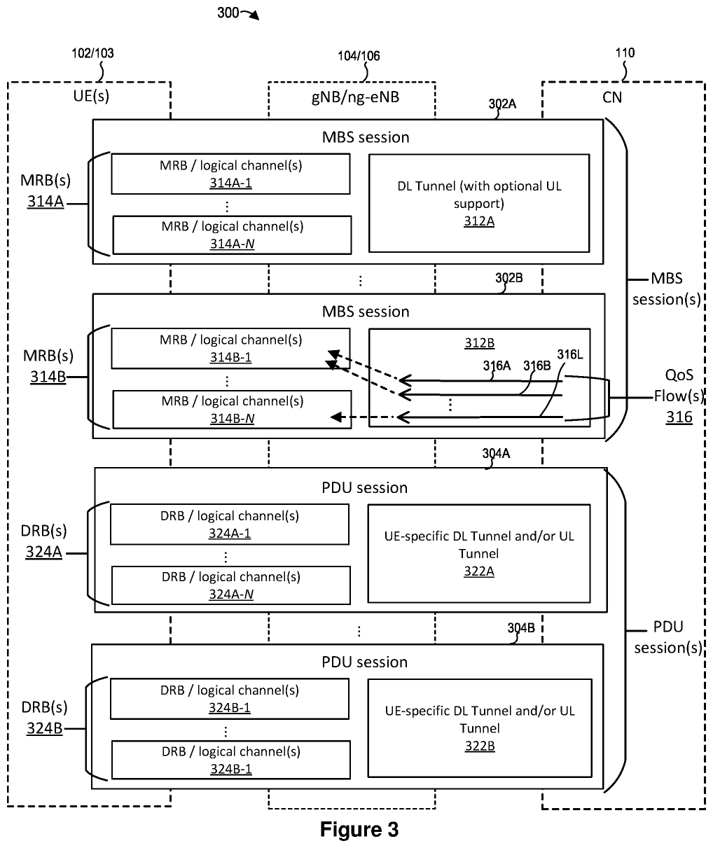

Referring to FIG. 3, an MBS session 302A can include a tunnel 312A with endpoints at the CN 110 and the base station 104/106. The MBS session 302A can correspond to a certain session ID such as a Temporary Mobile Group Identity (TMGI), for example. The MBS data can include IP packets, TCP/IP packets, UDP/IP packets, Real-Time Transport Protocol (RTP)/UDP/IP packets, or RTP/TCP/IP packets, for example.

In some cases, the CN 110 and/or the base station 104/106 configure the tunnel 312A only for MBS traffic directed from the CN 110 to the base station 104/106, and the tunnel 312A can be referred to as a downlink (DL) tunnel. In other cases, however, CN 110 and the base station 104/106 use the tunnel 312A for downlink as well as for uplink (UL) MBS traffic to support, for example, commands or service requests from the UEs. Further, because the base station 104/106 can direct MBS traffic arriving via the tunnel 312A to multiple UEs, the tunnel 312A can be referred to as a common tunnel or a common DL tunnel.

The tunnel 312A can operate at the transport layer or sublayer, e.g., on the User Datagram Protocol (UDP) protocol layered over Internet Protocol (IP). As a more specific example, the tunnel 312A can be associated with the General Packet Radio System (GPRS) Tunneling Protocol (GTP). The tunnel 312A can correspond to a certain IP address (e.g., an IP address of the base station 104/106) and a certain Tunnel Endpoint Identifier (TEID) (e.g., assigned by the base station 104/106), for example. More generally, the tunnel 312A can have any suitable transport-layer configuration. The CN 110 can specify the IP address and the TEID address in header(s) of a tunnel packet including an MBS data packet and transmit the tunnel packet downstream to the base station 104/106 via the tunnel 312A. The header(s) can include the IP address and/or the TEID. For example, the header(s) includes an IP header and a GTP header including the IP address and the TEID, respectively. The base station 104/106 accordingly can identify data packets traveling via the tunnel 312A using the IP address and/or the TEID.

As illustrated in FIG. 3, the base station 104/106 maps traffic in the tunnel 312A to N radio bearers 314A-1, 314A-2, . . . 314A-N, which may be configured as MBS radio bearers or MRBs, where N≥1. Each MRB can correspond to a respective logical channel. As discussed above, the PDCP sublayer provides support for radio bearers such as SRBs, DRBs, and MRBs, and a EUTRA or NR MAC sublayer provides logical channels to a EUTRA or NR RLC sublayer. Each of the MRBs 314A for example can correspond to a respective MBS Traffic Channel (MTCH). The base station 104/106 and the CN 110 can also maintain another MBS session 302B, which similarly can include a tunnel 312B corresponding to MRBs 314B-1, 314B-2, . . . 314B-N, where N≥1. Each of the MRBs 314B can correspond to a respective logical channel.

The MBS traffic can include one or multiple quality-of-service (QOS) flows, for each of the tunnels 312A, 312B, etc. For example, the MBS traffic on the tunnel 312B can include a set of flows 316 including QoS flows 316A, 316B, . . . 316L. Further, a logical channel of an MRB can support a single QoS flow or multiple QoS flows. In the example configuration of FIG. 3, the base station 104/106 maps the QoS flows 316A and 316B to the MTCH of the MRB 314B-1, and the QoS flow 316L to the MTCH of the MRB 314B-N.

In various scenarios, the CN 110 can assign different types of MBS traffic to different QoS flows. A flow with a relatively high QoS value can correspond to audio packets, and a flow with a relatively low QoS value can correspond to video packets, for example. As another example, a flow with a relatively high QoS value can correspond to I-frames or complete images used in video compression, and a flow with a relatively low QoS value can correspond to P-frames or predicted pictures that include only changes to I-frames.

With continued reference to FIG. 3, the base station 104/106 and the CN 110 can maintain one or more PDU sessions to support unicast traffic between the CN 110 and particular UEs. A PDU session 304A can include a UE-specific DL tunnel and/or UE-specific UL tunnel 322A corresponding to one or more DRBs 324A, such as a DRB 324A-1, 324A-2, . . . 324A-N. Each of the DRBs 324A can correspond to a respective logical channel, such as a Dedicated Traffic Channel (DTCH). The base station 104/106 and the CN 110 can also maintain one or more other PDU sessions to support unicast traffic between the CN 110 and particular UEs. For example, PDU session 304B can include a UE-specific DL tunnel and/or UE-specific UL tunnel 322B corresponding to one or more DRBs 324B, such as a DRB 324B-1, 324B-2, . . . 324B-N. Each of the DRBs 324B can correspond to a respective logical channel, such as a DTCH.

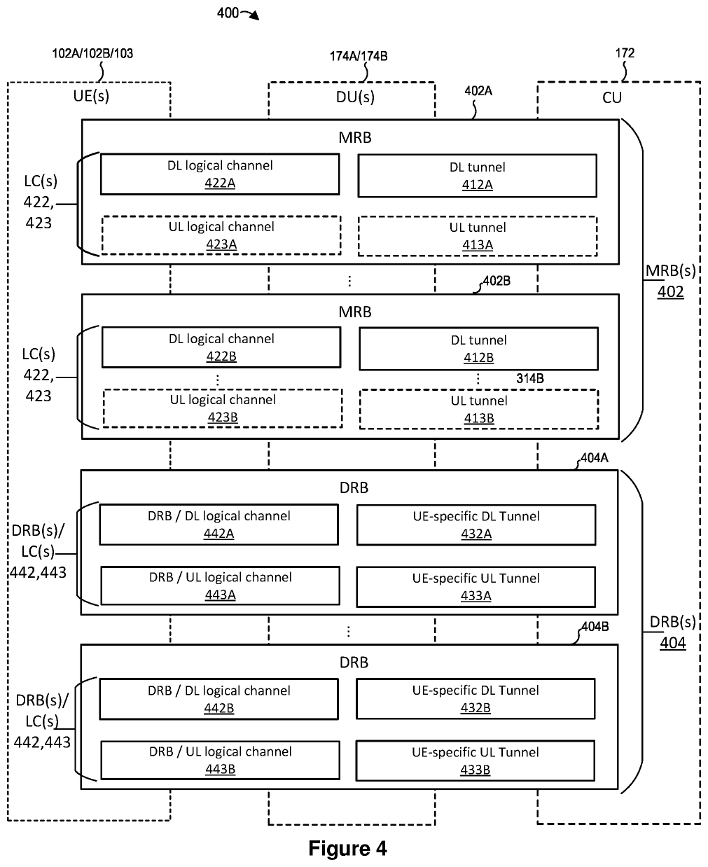

Now referring to FIG. 4, when the base station 104/106 is implemented in a distributed manner, one or more DUs 174A/174B can be associated with the CU 172. The CU 172 and the DU(s) 174A/174B can establish tunnels for downlink data and/or uplink data associated with an MRB or a DRB. The MRB 314A-1 discussed above can be implemented as an MRB 402A connecting the CU 172 to multiple UEs such as the UE 102A and 102B, for example. The MRB 402A can include a DL tunnel 412A connecting the CU 172 and the DU(s) 174A/174B, and a DL logical channel 422A corresponding to the DL tunnel 412A. In particular, the DU(s) 174A/174B can map downlink traffic received via the DL tunnel 412A to the DL logical channel 422A, which can be an MTCH or a DTCH, for example. The DL tunnel 412A can be a common DL tunnel via which the CU 172 transmits MBS data packets to multiple UEs. Alternatively, the DL tunnel 412A can be a UE-specific DL tunnel via which the CU 172 transmits MBS data packets to a particular UE.

Optionally, the MRB 402A also includes a UL tunnel 413A connecting the CU 172 and the DU(s) 174A/174B, and a UL logical channel 423A corresponding to the UL tunnel 413A. The UL logical channel 423A can be a DTCH, for example. The DU(s) 174A/174B can map uplink traffic received via the UL logical channel 423A to the UL tunnel 413A.

The tunnels 412A and 413A can operate at the transport layer or sublayer of the F1-U interface. As a more specific example, the CU 172 and the DU(s) 174A/174B can utilize an F1-U for user-plane traffic, and the tunnels 412A and 413A can be associated with the GTP-U protocol layered over UDP/IP, where IP is layered over suitable data link and physical (PHY) layers. Further, the MRB(s) 402 and/or the DRB(s) 404 in at least some of the cases additionally support control-plane traffic. More particularly, the CU 172 and the DU(s) 174A/174B can exchange F1-AP messages over an F1-C interface that relies on a Stream Control Transmission Protocol (SCTP) layered over IP, where IP is layered over suitable data link and PHY layers similar to F1-U.

Similarly, an MRB 402B can include a DL tunnel 412B and, optionally, an UL tunnel 413B. The DL tunnel 412B can correspond to a DL logical channel 422B, and the UL tunnel 413B can correspond to the UL logical channel 423B.

The CU 172 in some cases uses a DRB 404A to transmit MBS data packets or unicast data packets associated with a PDU session, to a particular UE (e.g., the UE 102A or the UE 102B). The DRB 404A can include a UE-specific DL tunnel 432A connecting the CU 172 and the DU(s) 174A/174B, and a DL logical channel 442A corresponding to the DL tunnel 432A. In particular, the DU(s) 174A/174B can map downlink traffic received via the DL tunnel 432A to the DL logical channel 442A, which can be a DTCH, for example. The DRB 404A further includes a UE-specific UL tunnel 433A connecting the CU 172 and the DU(s) 174A/174B, and a UL logical channel 443A corresponding to the UL tunnel 433A. The UL logical channel 443A can be a PUSCH, for example. The DU(s) 174A/174B can map uplink traffic received via the UL logical channel 443A to the UL tunnel 433A.

Similarly, a DRB 404B can include a UE-specific DL tunnel 432B corresponding to a DL logical channel 442B, and a UE-specific UL tunnel 433B corresponding to a UL logical channel 443B.

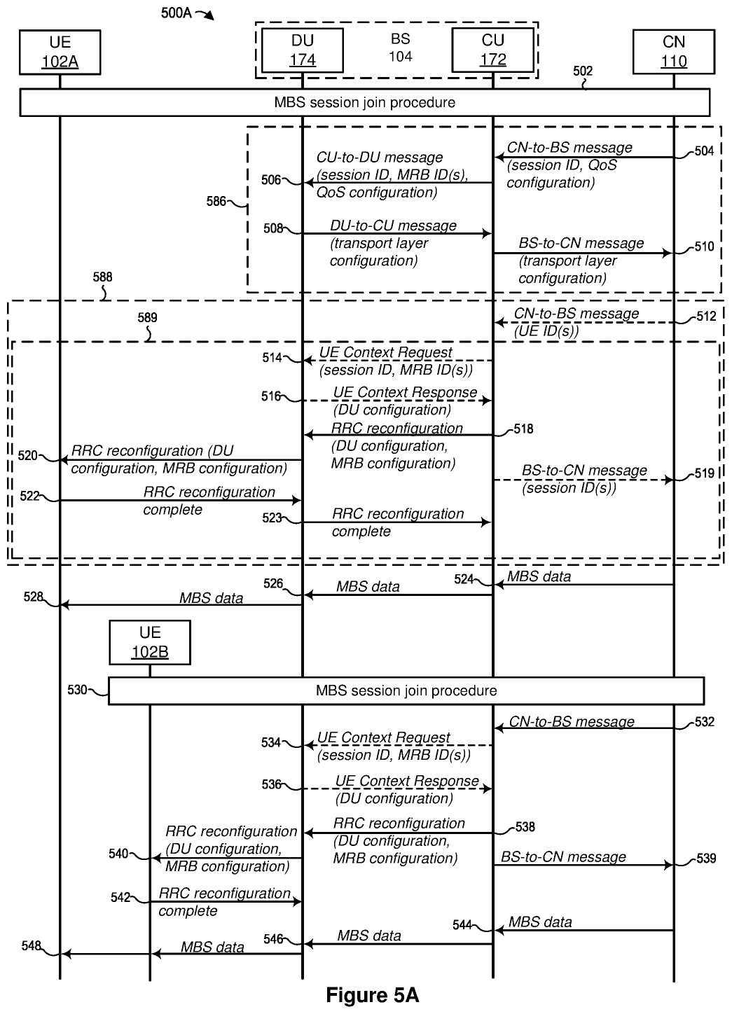

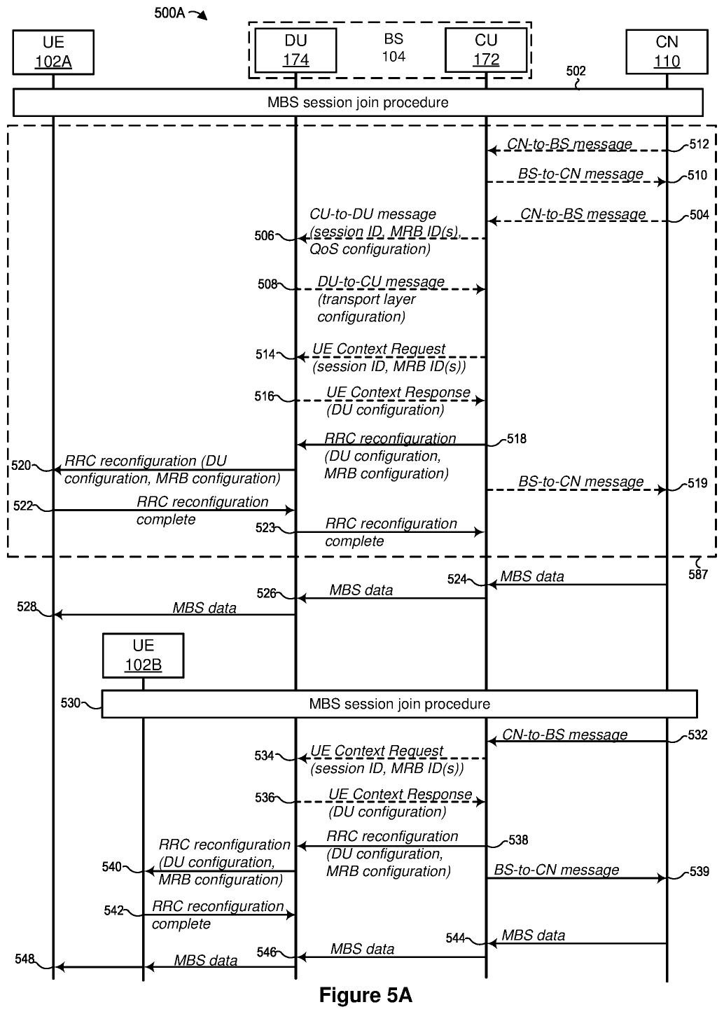

Referring to FIG. 5A, the UE 102A in a scenario 500A initially performs 502 an MBS session join procedure with the CN 110 via the base station 104 to join a certain MBS session. In some scenarios, the UE 102A subsequently performs additional one or more MBS join procedures, and event 502 accordingly is a first one of multiple MBS join procedures. When the base station 104 configures a common DL tunnel for MBS traffic rather than a UE-specific tunnel, the procedures 502 and 586 can occur in either order. In other words, the base station 104 can configure a common DL tunnel before even a single UE joins the MBS session.

To perform the MBS session join procedure (event 502), the UE 102A in some implementations sends an MBS session join request message to the CN 110 via the base station 104. In response, the CN 110 can send an MBS session join response message to the UE 102A via the base station 104 to grant the UE 102A access to the first MBS session. In some implementations, the UE 102A can include an MBS session ID of the MBS session in the MBS session join request message. The CN 110 in some cases includes the MBS session ID in the MBS session join response message. In some implementations, the UE 102A can send an MBS session join complete message to the CN 110 via the base station 104 in response to the MBS session join response message.

The UE 102A in some cases performs additional MBS session join procedure(s) with the CN 110 via the RAN 105 (e.g., the base station 104 or base station 106) to join additional MBS session(s). For example, the UE 102A can perform a second MBS session join procedure with the CN 110 via the RAN 105 to join a second MBS session. Similar to event 502, the UE 102A in some implementations can send a second MBS session join request message to the CN 110 via the base station 104, and the CN 110 can respond with a second MBS session join response message to grant the UE 102A access to the second MBS session. In some implementations, the UE 102A can send a second MBS session join complete message to the CN 110 via the base station 104 in response to the second MBS session join response message. In some implementations, the UE 102A can include a second MBS session ID of the second MBS session in the second MBS session join request message. The CN 110 optionally includes the second MBS session ID in the second MBS session join response message. In some implementations, the UE 102A can include the first and second MBS session IDs in an MBS session join request message (e.g., the first MBS session join request message) to request to join the first and second MBS sessions at the same time. In such cases, the CN 110 can send an MBS session response message to grant either the first MBS session or the second MBS session, or both the first and MBS sessions.

In some implementations, the MBS session join request message, MBS session join response message, and MBS session join complete message can be session initiation protocol (SIP) messages. In other implementations, the MBS session join request message, MBS session join response message, and MBS session join complete message can be NAS messages such as 5G mobility management (5GMM) messages or 5G session management (5GSM) messages. In the case of the 5GSM messages, the UE 102A can transmit to the CN 110 via the base station 104 a (first) UL container message including the MBS session join request message, the CN 110 can transmit to the UE 102A via the base station 104 a DL container message including the MBS session join response message, and the UE 102A can transmit to the CN 110 via the base station 104 a (second) UL container message including the MBS session join complete message. These container messages can alternatively be 5GMM messages. In some implementations, the MBS session join request message, MBS session join response message, and MBS session join complete message can be a PDU Session Modification Request message, a PDU Session Modification Command message, and a PDU Session Modification Complete message, respectively. To simplify the following description, the MBS session join request message, the MBS session join response message, and/or the MBS session join complete message can also represent their respective container messages.

In some implementations, the UE 102A can perform (not shown) a PDU session establishment procedure with the CN 110 via the base station 104 to establish a PDU session in order to perform the (first) MBS session join procedure. During the PDU session establishment procedure, the UE 102A can communicate a PDU session ID of the PDU session with the CN 110 via the base station 104.

Before, during, or after the (first) MBS session join procedure (event 502), the CN 110 can send 504 a (first) CN-to-BS message including the first MBS session ID and/or PDU session ID to the CU 172 to request the CU 172 to configure resources for the first MBS session. In response to receiving 504 the first CN-to-BS message, the CU 172 sends 506 a CU-to-DU message to the DU 174 to request a set-up for an MBS context and/or a common DL tunnel for the first MBS session. In response to receiving 506 the CU-to-DU message, the DU 174 sends 508, to the CU 172, a DU-to-CU message including a first DU DL transport layer configuration to configure a common CU-to-DU DL tunnel for the first MBS session (e.g., for a MRB identified by one of the MRB ID(s)). The DU 174 can include, in the DU-to-CU message, additional DL transport layer configuration(s) to configure additional common CU-to-DU DL tunnel(s) for additional MRB(s) identified by additional MRB ID(s) of the MRB IDs. In some implementations, the DU 174 can include, in the DU-to-CU message, the MRB ID(s) associated with the first DL transport layer configuration and/or the additional DL transport layer configuration(s). In some implementations, the CU-to-DU message is a generic F1AP message or a dedicated F1AP message defined specifically to convey this type of a request (e.g., MBS Context Setup Request message). In some implementations, the DU-to-CU message of event 508 is a generic F1AP message or a dedicated F1AP message defined specifically for this purpose (e.g., MBS Context Setup Response message). The CN 110 can additionally include quality of service (QOS) configuration(s) for the first MBS session in the first CN-to-BS message. In such cases, the CU 172 can include the QoS configuration(s) in the CU-to-DU message (event 506).

The CU 172 sends 510 a first BS-to-CN message (e.g., MBS Session Resource Setup Response message) in response to the message of event 504. The CU 172 can include the first MBS session ID and/or the PDU session ID in the first BS-to-CN message. The first BS-to-CN message can include a DL transport layer configuration to configure a common DL tunnel for the CN 110 to send MBS data to the CU 172. The DL transport layer configuration includes a transport layer address (e.g., an IP address and/or a TEID) to identify the common DL tunnel. In some implementations, the CN-to-BS message of event 504 is a generic NGAP message or a dedicated NGAP message defined specifically for requesting resources for an MBS session (e.g., MBS Session Resource Setup Request message). In some implementations, the BS-to-CN message of event 510 is a generic NGAP message or a dedicated NGAP message defined specifically to convey resources for an MBS session (e.g., MBS Session Resource Setup Response message). In such cases, the CN-to-BS message of event 504 and the BS-to-CN message of event 510 can be non-UE-specific messages.

In some implementations, the QoS configuration(s) include QoS parameters for the MBS session. In some implementations, the QoS configuration includes configuration parameters to configure one or more QoS flows for the MBS session (see FIG. 3). In some implementations, the configuration parameters include one or more QoS flow IDs identifying the QoS flow(s). Each of the QoS flow ID(s) identifies a particular QoS flow of the QoS flow(s). In some implementations, the configuration parameters include QoS parameters for each QoS flow. The QoS parameters can include a 5G QoS identifier (5QI), a priority level, packet delay budget, packet error rate, averaging window, and/or a maximum data burst volume. The CN 110 can specify different values of the QoS parameters for the QoS flows.

The events 504, 506, 508, and 510 are collectively referred to in FIG. 5A as an MBS session resource setup procedure 586.

In cases where the CN 110 grants the additional MBS session(s) for the UE 102A in the additional MBS session join procedure(s), the CN 110 can include the additional MBS session ID(s) and, optionally, QoS configuration(s) for the additional MBS session ID(s) in the first CN-to-BS message, a subsequent CN-to-BS message, or additional CN-to-BS message(s) similar to the first or subsequent CN-to-BS message. In such cases, the CU 172 includes additional transport layer configuration(s) for the additional MBS session(s) to configure additional common DL tunnel(s) in the first BS-to-CN message, a subsequent BS-to-CN message, or additional BS-to-CN message(s) similar to the first or subsequent BS-to-CN message. Each of the transport layer configuration(s) configures a particular common DL tunnel of the common DL tunnel(s) and can be associated to a particular MBS session of the additional MBS session(s). Alternatively, the CN 110 can perform additional MBS session resource setup procedure(s) with the CU 172 to obtain the additional transport layer configuration(s) from the CU 172, similar to the single-session MBS session resource setup procedure 586 shown in FIG. 5A. The transport layer configurations can be different to distinguish between different common DL tunnels. In particular, any pair of the transport layer configurations can have different IP addresses, different DL TEIDs, or different IP addresses as well as different DL TEIDs.

In some implementations, the CN 110 can indicate, in the first CN-to-BS message, a list of UEs joining the first MBS session. In other implementations, the CN 110 can send 512 to the CU 172 a second CN-to-BS message indicating a list of UEs joining the first MBS session. The CN 110 can include the first MBS session ID and/or the PDU session ID in the second CN-to-BS message. The CU 172 can send 519 a second BS-to-CN message to the CN 110 in response to the second CN-to-BS message 512. In such cases, the second CN-to-BS message can be a non-UE-specific message, i.e., a message not specific for the UE 102A or the UE 102B. The CU 172 can include the first MBS session ID and/or the PDU session ID in the second BS-to-CN message. For example, the list of UEs includes the UE 102A and/or UE 102B. To indicate a list of UEs, the CN 110 can include a list of (CN UE interface ID, RAN UE interface ID) pairs, each identifying a particular UE of the UEs. The CN 110 assigns the CN UE interface ID, and the CU 172 assigns the RAN UE interface ID. Before the CN 110 sends 512 the list of (CN UE interface ID, RAN UE interface ID) pairs in the second CN-to-BS message, the CU 172 sends (not shown) a BS-to-CN message (e.g., a NGAP message, an INITIAL UE MESSAGE or PATH SWITCH REQUEST message) including the RAN UE interface ID to the CN 110 for each of the UEs, and the CN 110 sends (not shown) a CN-to-BS message (e.g., a NGAP message, an INITIAL CONTEXT SETUP REQUEST message or PATH SWITCH REQUEST ACKNOWLEDGE message) including the CN UE interface ID to the CU 172 for each of the UEs. In one example, the list of pairs includes a first pair of (a first CN UE interface ID and a first RAN UE interface ID) identifying the UE 102A and a second pair of (a second CN UE interface ID, a second RAN UE interface ID) identifying the UE 102B. In some implementations, the “CN UE interface ID” can be an “AMF UE NGAP ID” and the “RAN UE interface ID” can be a “RAN UE NGAP ID”. In other implementations, the CN 110 can include a list of UE IDs each identifying a particular UE of the UEs. In some implementations (not shown), the CN 110 can assign the UE IDs and send each of the UE IDs to a particular UE of the UEs in a NAS procedure (e.g., a registration procedure) that the CN 110 performs with the particular UE. For example, the list of UE IDs can include a first UE ID of the UE 102A and a second UE ID of the UE 102B. In some implementations, the UE IDs are S-Temporary Mobile Subscriber Identities (S-TMSIs) (e.g., 5G-S-TMSIs). Before the CN 110 sends 512 the list of UE IDs, the CU 172 can receive (not shown) the UE ID from the UE 102 or the CN 110 for each of the UEs. For example, the CU 172 can receive (not shown) a RRC message (e.g., a RRCSetupComplete message) including the UE ID from the UE 102 during a RRC connection establishment procedure. In another example, the CU 172 can receive (not shown) a CN-to-BS message (e.g., a NGAP message, an INITIAL CONTEXT SETUP REQUEST message or UE INFORMATION TRANSFER message) including the UE ID from the CN 110.

In other implementations, the CN 110 can send 512 to the CU 172 a second CN-to-BS message indicating (only) the UE 102 (e.g., either the UE 102A or the UE 102B) that joins the first MBS session. The second CN-to-BS message can be a UE-associated message for the UE 102. That is, the second CN-to-BS message is specific for the UE 102. In response to receiving the second CN-to-BS message, the CU 172 can send 514 to the DU 174 a UE Context Request message for the UE 102. In some implementations, the CU 172 can include, in the UE Context Request message, the first MBS session ID and/or MRB ID(s) of MRB(s) associated to the first MBS session (ID). In response to the UE Context Request message, the DU 174 sends 516 to the CU 172 a UE Context Response message including configuration parameters for the UE 102A to receive MBS data of the first MBS session. In some implementations, the CU 172 can include QoS configuration(s) in the UE Context Request message. In such cases, the CU 172 might or might not include the QoS configuration(s) in the CU-to-DU message sent 506 during the MBS session resource setup procedure 586. (Some of) the configuration parameters may be associated to the MRB(s)/MRB ID(s). In some implementations, the DU 174 generates a DU configuration to include the configuration parameters and includes the DU configuration in the UE Context Response message. In some implementations, the DU configuration can be a CellGroupConfig IE. In other implementations, the DU configuration can be an MBS specific IE. In some implementations, the configuration parameters configure one or more logical channels (LCs). For example, the configuration parameters can include one or more logical channel IDs (LCIDs) to configure the one or more logical channel. Each of the LCIDs identifies a particular logical channel of the one or more logical channels.

In some implementations, the second CN-to-BS message and the second BS-to-CN message can be a PDU Session Resource Modify Request message and a PDU Session Resource Modify Response message, respectively. In some implementations, the second CN-to-BS message and the second BS-to-CN message can be UE-associated messages, i.e., the messages are associated to a particular UE (e.g., the UE 102A or 102B).

In cases where the CN 110 grants the additional MBS session(s) for the UE 102A in the additional MBS session join procedure(s), the CN 110 can include the additional MBS session ID(s) and/or QoS configuration(s) for the additional MBS session ID(s) in the first CN-to-BS message or the second CN-to-BS message. In such cases, the CU 172 can include the additional MBS session ID(s) and MRB ID(s) in the CU-to-DU message, and the DU 174 include, in the DU-to-CU message, additional DU transport layer configuration(s) to configure additional CN-to-BS DL tunnel(s) for the additional MBS session(s). Alternatively, the CU 172 can perform additional MBS session resource setup procedure(s) with the DU 174 to obtain the additional DU DL transport layer configuration(s), similar to the events 506 and 508. In some implementations, the CU 172 includes, in the first BS-to-CN message, additional CU DL transport layer configuration(s) for the additional MBS session(s) to configure additional CN-to-BS common DL tunnel(s). Each of the transport layer configuration(s) configures a particular DL tunnel of the common CN-to-BS DL tunnel(s) and can be associated to a particular MBS session of the additional MBS session(s). Alternatively, the CN 110 can perform additional MBS session resource setup procedure(s) with the CU 172 to obtain the additional CU DL transport layer configuration(s) from the CU 172, similar to the MBS session resource setup procedure 586. The transport layer configurations can be different to distinguish between different common DL tunnels. In particular, any pair of the transport layer configurations can have different IP addresses, different DL TEIDs, or different IP addresses as well as different DL TEIDs.

In some implementations, the CN 110 includes the QoS configuration(s) in the second CN-to-BS message. In such cases, the CN 110 may include the QoS configuration(s) in the first CN-to-BS message, or omit the QoS configuration(s). In some implementations, the DU 174 generates the configuration parameters for the UE 102A to receive MBS data of the first MBS session in response receiving 506 the CU-to-DU message or receiving 514 the UE Context Request message. In some implementations, the CU 172 includes the QoS configuration(s) in the UE Context Request message and/or the CU-to-DU message. The DU 174 can determine the content of the configuration parameters in accordance with the QoS configuration(s). When the CU 172 includes the QoS configuration(s) neither in the CU-to-DU message nor the UE Context Request message, the DU 174 can determine values of the configuration parameters in accordance with a predetermined (default) QoS configuration.

In some implementations, the UE Context Request message and the UE Context Response message are a UE Context Setup Request message and a UE Context Setup Response message, respectively. In other implementations, the UE Context Request message and the UE Context Response message are a UE Context Modification Request message and a UE Context Modification Response message, respectively.

After receiving 516 the UE Context Response message, the CU 172 generates an RRC reconfiguration message including the configuration parameters and one or more MRB configurations and transmits 518 the RRC reconfiguration message to the DU 174. In turn, the DU 174 transmits 520 the RRC reconfiguration message to the UE 102. The UE 102 then transmits 522 a RRC reconfiguration complete message to the DU 174, which in turn transmits 523 the RRC reconfiguration complete message to the CU 172.

The events 512, 514, 516, 518, 519, 520, 522 and 523 are collectively referred to in FIG. 5A as an MBS radio connection reconfiguration procedure 588. The events 514, 516, 518, 520, 522 and 523 are collectively referred to in FIG. 5A as an MBS radio connection reconfiguration procedure 589.

In some implementations, the CU 172 generates a PDCP PDU including the RRC reconfiguration message and sends 518 a CU-to-DU message including the PDCP PDU to the DU 174, and the DU 174 retrieves the PDCP PDU from the CU-to-DU message and transmits 520 the PDCP PDU to the UE 102 via the RLC layer 206B, MAC layer 204B, and PHY layer 202B. The UE 102 receives 520 the PDCP PDU from the DU 174 via the PHY layer 202B, MAC layer 204B and RLC layer 206B. In some implementations, the UE 102 generates a PDCP PDU including the RRC reconfiguration complete message and transmits 522 the PDCP PDU to the DU 174 via the RLC layer 206B, MAC layer 204B, and PHY layer 202B. The DU 174 receives 522 the PDCP PDU from the UE 102 via the PHY layer 202B. MAC layer 204B, and RLC layer 206B and sends 523 a DU-to-CU message including the PDCP PDU to the CU 172. The CU 172 retrieves the PDCP PDU from the DU-to-CU message and retrieves the RRC reconfiguration complete message from the PDCP PDU.

Before or after receiving 516 the UE Context Response message, the CU 172 can send 519 a second BS-to-CN message to the CN 110 in response to the second CN-to-BS message 512. In some implementations, the CU 172 sends 519 the second BS-to-CN message to the CN 110 before receiving 523 the RRC reconfiguration complete message. In other implementations, the CN 110 sends 519 the second BS-to-CN message to the CN 110 after receiving 523 the RRC reconfiguration complete message. The CU 172 can include the first CN UE interface ID and the first RAN UE interface ID in the second BS-to-CN message. Alternatively, the CU 172 can include the first UE ID in the second BS-to-CN message.

In some implementations, respective instances of the MBS radio connection reconfiguration procedure 588 occur for each of the UE 102A and the UE 102B. The configuration parameters for the UE 102A and the UE 102B to receive MBS data of the first MBS session can be the same.

In some implementations, the CU 172 includes the CU DL transport layer configuration(s) in the second BS-to-CN message and/or a subsequent BS-to-CN message. In other words, the CU 172 can send the same CU DL transport layer configuration(s) in BS-to-CN messages in responses to CN-to-BS messages indicating UEs joining the same MBS session. In such implementations, the CN 110 can blend the MBS resource setup procedure 586 and the MBS radio connection reconfiguration procedure 588 into a single procedure.

In cases where the CU 172 performs the MBS resource setup procedure 586 (e.g., events 504, 510) with the CN 110 to establish the common CN-to-BS DL tunnel for the first MBS session, the CU 172 may refrain from including a DL transport layer configuration for the first MBS session in the second BS-to-CN message. In such cases, the CN 110 may refrain from including a UL transport layer configuration for the first MBS session in the second CN-to-BS message. In cases where the DU 174 performs the MBS resource setup procedure 586 (e.g., events 506, 508) with the CU 172 to establish the common CU-to-DU DL tunnel for the first MBS session, the DU 174 may refrain from including a DL transport layer configuration for the first MBS session in the UE Context Response message. In such cases, the CU 172 may refrain from including a UL transport layer configuration for the first MBS session in the UE Context Request message.

After receiving 510 the first BS-to-CN message or receiving 519 the second BS-to-CN message, the CN 110 can send 524 MBS data (e.g., one or multiple MBS data packets, also interchangeably referred to herein as “MBS content data” or “MBS payload data”) to the CU 172 via the common CN-to-BS DL tunnel, which in turn sends the 526 the MBS data to the DU 174 via the common CU-to-DU tunnel. The DU 174 transmits (e.g., multicast or unicast) 528 the MBS data via the one or more logical channels to the UE 102 (i.e., the UE 102A and the UE 102B). The UE 102 receives 528 the MBS data via the one or more logical channels. For example, the CU 172 receives 524 an MBS data packet, generates a PDCP PDU including the MBS data packet and transmits 526 the PDCP PDU to the DU 174. In turn, the DU 174 generates a MAC PDU including the logical channel ID and the PDCP PDU, and transmits 528 the MAC PDU to the UE 102 via multicast or unicast. The UE 102 receives 528 the MAC PDU via multicast or unicast, retrieves the PDCP PDU and the logical channel ID from the MAC PDU, identifies the PDCP PDU associated with the MRB in accordance with the logical channel ID, and retrieves the MBS data packet from the PDCP PDU in accordance with a PDCP configuration within the MRB configuration.

In some implementations, the CU 172 can (determine to) configure a UE-specific CN-to-BS DL tunnel for the UE 102 in response to receiving 504 the first CN-to-BS message or receiving 512 the second CN-to-BS message. In such cases, the CU 172 can omit the event 506, and can include, in the second BS-to-CN message, a DL transport layer configuration configuring a UE-specific DL tunnel. The CN 110 can transmit 524 the MBS data to the CU 172 via the UE-specific CN-to-BS DL tunnel. In some implementations, the CU 172 can (determine to) configure a UE-specific CU-to-DU DL tunnel for the UE 102 in response to receiving 504 the first CN-to-BS message or receiving 512 the second CN-to-BS message. In such cases, the CU 172 can omit the event 510 and the DU 174 can include, in the UE Context Response message, a DL transport layer configuration configuring a UE-specific CU-to-DU DL tunnel. In such cases, the CU 174 can transmit 526 the MBS data to the DU 174 via the UE-specific CU-to-DU DL tunnel.

In some implementations, the one or more MRB configurations configuring one or more MRBs are associated with the first MBS session. In some implementations, the configuration parameters also include one or more RLC bearer configurations, each associated with a particular MRB. Each of the MRB configuration(s) can include a MRB ID, a PDCP configuration, the first MBS session ID, a PDCP reestablishment indication (e.g., reestablishPDCP), and/or a PDCP recovery indication (e.g., recoveryPDCP). In some implementations, the PDCP configuration can be a PDCP-Config IE for DRB. In some implementations, the RLC bearer configuration can be an RLC-BearerConfig IE. In some implementations, the RLC bearer configuration may include a logical channel (LC) ID configuring a logical channel. In some implementations, the logical channel can be a multicast traffic channel (MTCH). In other implementations, the logical channel can be a dedicated traffic channel (DTCH). In some implementations, the configuration parameters may include logical channel configuration (e.g., LogicalChannelConfig IE) configuring configure the logical channel. In some implementations, the RLC bearer configuration may include the MRB ID.

In some implementations, the CU 172 can configure the MRB as a DL-only RB in the MRB configuration. For example, the CU 172 refrains from including UL configuration parameters in the PDCP configuration within the MRB configuration to configure the MRB as a DL only RB. The CU 172 only includes DL configuration parameters in the MRB configuration, e.g., as described above. In such cases, the CU 172 configures the UE 102 not to transmit UL PDCP data PDU via the MRB to the DU 174 and/or the CU 172 by excluding the UL configuration parameters for the MRB in the PDCP configuration in the MBR configuration. In another example, the DU 174 refrains from including UL configuration parameters in the RLC bearer configuration. In such cases, the DU 174 configures the UE 102 not to transmit control PDU(s) via the logical channel to the base station 104 by excluding the UL configuration parameters from the RLC bearer configuration.

In cases where the DU 174 includes UL configuration parameter(s) in the RLC bearer configuration, the UE 102 may transmit control PDU(s) (e.g., PDCP Control PDU(s) and/or RLC Control PDU(s)) via the logical channel to the DU 174 using the UL configuration parameter(s). If the control PDU is a PDCP control PDU, the DU 174 can send the PDCP control PDU to the CU 172. For example, the CU 172 may configure the UE to receive MBS data with a (de) compression protocol (e.g., robust header compression (ROHC) protocol), e.g., in the MRB configuration. In this case, when the CU 172 receives 524 an MBS data packet from the CN 110, the CU 172 compresses the MBS data packet with the compression protocol to obtain a compressed MBS data packet and transmits 526 a PDCP PDU including the compressed MBS data packet to the DU 174 via the common CU-to-DU DL tunnel. In turn, the DU 174 transmits (e.g., multicast or unicast) 528 the PDCP PDU to the UE 102 via the logical channel. When the UE 102 receives the PDCP PDU via the logical channel, the UE 102 retrieves the compressed MBS data packet from the PDCP PDU. The UE 102 decompresses the compressed MBS data packet with the (de) compression protocol to obtain the original MBS data packet. In such cases, the UE 102 may transmit a PDCP Control PDU including, a header compression protocol feedback (e.g., interspersed ROHC feedback) for operation of the header (de) compression protocol, via the logical channel to the DU 174. In turn, the DU 174 sends the PDCP Control PDU to the CU 172 via a UE-specific UL tunnel, i.e., the UL tunnel is specific for the UE 102 (e.g., the UE 102A). In some implementations, the CU 172 can include, in the UE Context Request message, a CU UL transport layer configuration configuring the UE-specific UL tunnel. The CU UL transport layer configuration includes a CU transport layer address (e.g., an Internet Protocol (IP) address) and a CU UL TEID to identify the UE-specific UL tunnel.

In some implementations, the MRB configuration can be an MRB-ToAddMod IE including an MRB ID (e.g., mrb-Identity or MRB-Identity). A MRB ID identifies a particular MRB of the MRB(s). The base station 104 set the MRB IDs to different values. In cases where the CU 172 has configured DRB(s) to the UE 102 for unicast data communication, the CU 172 in some implementations can set one or more of the MRB ID(s) to values different from DRB ID(s) of the DRB(s). In such cases, the UE 102 and the CU 172 can distinguish whether an RB is a MRB or DRB in accordance an RB ID of the RB. In other implementations, the CU 172 can set one or more of the MRB ID(s) to values which can be the same as the DRB ID(s). In such cases, the UE 102 and the CU 172 can distinguish whether an RB is a MRB or DRB in accordance an RB ID of the RB and a RRC IE configuring the RB. For example, a DRB configuration configuring a DRB is a DRB-ToAddMod IE including a DRB identity (e.g., drb-Identity or DRB-Identity) and a PDCP configuration. Thus, the UE 102 can determine an RB is a DRB if the UE 102 receives a DRB-ToAddMod IE configuring the RB, and determine an RB is an MRB if the UE 102 receives an MRB-ToAddMod IE configuring the RB. Similarly, the CU 172 can determine an RB is a DRB if the CU 172 transmits a DRB-ToAddMod IE configuring the RB to the UE 102, and determine an RB is an MRB if the CU 172 transmits an MRB-ToAddMod IE configuring the RB to the UE 102.

In some implementations, the configuration parameters for receiving MBS data of the first MBS session include one or more logical channel (LC) IDs to configure one or more logical channels. In some implementations, the logical channel(s) can be dedicated traffic channel(s) (DTCH(s)). In other implementations, the logical channel(s) can be multicast traffic channel(s) (MTCH(s)). In some implementations, the configuration parameters may or may not include a group radio network temporary identifier (G-RNTI). The RRC reconfiguration messages for UEs (e.g., the UE 102A and the UE 102B) joining the first MBS session, include the same configuration parameters for receiving MBS data of the first MBS session. In some implementations, the RRC reconfiguration messages for the UEs may include the same or different configuration parameters for receiving non-MBS data.

In some implementations, the CU 172 can include the MBS session join response message in the RRC reconfiguration message. The UE 102 can include the MBS session join complete message in the RRC reconfiguration complete message. Alternatively, the UE 102 can send a UL RRC message including the MBS session join complete message to the CU 172 via the DU 174. The UL RRC message can be a ULInformationTransfer message or any suitable RRC message that can include a UL NAS PDU. The CU 172 can include the MBS session join complete message in the second BS-to-CN message. Alternatively, the CU 172 can send to the CN 110 a BS-to-CN message (e.g., an UPLINK NAS TRANSPORT message) including the MBS session join complete message.

In other implementations, the CU 172 transmits a DL RRC message that includes the MBS session join response message to the UE 102. The DL RRC message can be a DLInformationTransfer message, another RRC reconfiguration message, or any suitable RRC message that can include a DL NAS PDU. The UE 102 can send a UL RRC message including the MBS session join complete message to the CU 172 via the DU 174. The UL RRC message can be a ULInformationTransfer message, another RRC reconfiguration complete message or any suitable RRC message that can include a UL NAS PDU.

With continued reference to FIG. 5A, the UE 102B can perform 530 an MBS session join procedure similar to the procedure 502 discussed above. The UE 102B can perform a PDU session establishment procedure with the CN 110 via the base station 104 as described with reference to procedure 502. The UE 102B can communicate a PDU session ID with the CN 110 in the PDU session establishment procedure. The UE 102B can join the same MBS session as the UE 102A by sending an MBS session join request and specifying the same MBS session ID. In this example scenario, the UE 102B joins the MBS session after the base station 104 has started transmitting 528 MBS data packets to the UE 102A. The CN 110 transmits 532, to the CU 172, a CN-to-BS message including the MBS session ID and/or the PDU session ID in order to indicate that the UE 102B should start receiving MBS data for an MBS session corresponding to the MBS session ID.

In some scenarios, the CU 172 or CN 110 determines that a DL tunnel for the MBS session identified in the event 532 already exists, and that there is no need to perform the procedure 586. Optionally, however, the CU 172 sends 534 a CU-to-DU message to the DU 174 to trigger an MBS radio connection reconfiguration procedure for the first MBS session similar to event 589, and the DU 174 responds 536 with a DU configuration.

The CU 172 transmits 538 an RRC reconfiguration message to the DU 174, and the DU 174 transmits 540 the RRC reconfiguration message to the UE 102B to configure the UE 102B to receive the MBS traffic. The RRC reconfiguration message can include the same LCID (value), MRB configuration, and RLC bearer configuration as the event 520, when the UEs 102A and 102B operate in the same cell. When the UEs 102A and 102B operate in different cells, the RRC reconfiguration message can have a different G-RNTI, LCID, and/or RLC bearer configuration, for example. The RRC reconfiguration message can include the same MRB configuration as the event 520, when the UEs 102A and 102B operate in different cells. As illustrated in FIG. 3, the CU 172 can map data packets arriving via the common CN-to-BS DL tunnel to one or more MRBs, each corresponding to a common CU-to-DU DL tunnel and/or a respective logical channel.

The UE 102B transmits 542 an RRC reconfiguration complete message(s) (e.g., RRCReconfiguration Complete message(s)) to the base station 104 in response to the RRC reconfiguration message(s) of event 540, which can be received 542 by the DU 174. In response to the DU 174 of the base station 104 receiving 542 the RRC reconfiguration complete message, the DU 174 transmits 543 an RRC reconfiguration complete message to the CU 172. Before or after receiving 542 the RRC reconfiguration complete message(s), the base station 104 in some cases sends 539 another BS-to-CN message to the CN 110, e.g., in a manner generally similar to the event 519. The BS-to-CN message can indicate an updated list of UEs associated with the MBS session specified in the event 532, for example. After the UE 102B has joined 530 the MBS session and obtained 540 the necessary RRC configuration, the CU 172 continues to receive 544 MBS data via the common CN-to-BS DL tunnel and transmits 546 the MBS data to the DU 174 via the common CU-to-DU DL tunnel. In some implementations, the DU 174 transmits 548 the MBS data to the UE 102A and UE 102B via multicast. The UE 102A and UE 102B can receive 548 MBS data similar to event 528. Alternatively, the base station 104 can transmit 548 the MBS data to the UE 102A and UE 102B separately via unicast.

Referring next to FIG. 5B, a scenario 500B is depicted which is generally similar to the scenario 500A. Events in this scenario similar to those discussed above are labeled with the same reference numbers and the examples and implementations for FIG. 5A can apply to FIG. 5B. The differences between the scenarios of FIG. 5A and FIG. 5B are discussed below.

In some implementations, the CU 172 can perform an MBS session resource setup procedure and UE-specific MBS session configuration procedure 587 (e.g., a combination of events 586 and 589) with the CN 110 in response to receiving 512 the second CN-to-BS message specifying the UE ID and a session ID for UE 102A. In such implementations, the CU 172 transmits 510 the first BS-to-CN message to the CN 110 in response to receiving 512 the second CN-to-BS message. Then, the CN 110 transmits 504 the first CN-to-BS message to the CU 172 in response to receiving 510 the first BS-to-CN message. In such cases, the CN 110 may or may not include an MBS session ID (i.e., the first MBS session ID) in the first CN-to-BS message. The CN 110 can transmit 519 the second BS-to-CN message in response to or after receiving 512 the second CN-to-BS message or receiving 504 the first CN-to-BS message. After or in response to receiving 512 the second CN-to-BS message, transmitting 510 the first BS-to-CN message, or receiving 504 the first CN-to-BS message, the CU 172 can transmit 506 the CU-to-DU message to the DU 174.

Instead of the CU 172 transmitting 506 the CU-to-DU message to request to configure a common CU-to-DU DL tunnel, the DU 174 in some implementations can transmit 508 the DU-to-CU message in response to receiving 514 the UE Context Request message in addition to transmitting 516 the UE Context Response message. Then, the CU 172 can send 508 a CU-to-DU response message to the DU 174 in response to receiving 506 the DU-to-CU message. In such cases, the DU-to-CU message and the CU-to-DU response message can be non-UE associated messages, i.e., the messages are not associated to a particular UE.

Thus, the events 512, 510, 504, 506, 508, 514, 516, 518, 519, 520, 522 and 523 are collectively referred to in FIG. 5B as an MBS resource setup and UE-specific MBS session configuration procedure 587. In cases where the CN 110 grants the additional MBS session(s) for the UE 102A in the additional MBS session join procedure(s), the CN 110 can perform MBS resource setup and UE-specific MBS session configuration procedure(s) with the base station 104 and UE 102A, similar to the procedure 587. In such cases, the CN 110 can include the additional MBS session ID(s) and, optionally, QoS configuration(s) for the additional MBS session ID(s) in CN-to-BS message(s) in the MBS resource setup and UE-specific MBS session configuration procedure(s), similar to the first or second CN-to-BS message. In such cases, the CU 172 includes additional transport layer configuration(s) for the additional MBS session(s) to configure additional common DL tunnel(s) in BS-to-CN message(s) in the MBS resource setup and UE-specific MBS session configuration procedure(s), similar to the first or second BS-to-CN message. Each of the transport layer configuration(s) configures a particular common DL tunnel of the common DL tunnel(s) and can be associated to a particular MBS session of the additional MBS session(s). The transport layer configurations can be different to distinguish between different common DL tunnels. In particular, any pair of the transport layer configurations can have different IP addresses, different DL TEIDs, or different IP addresses as well as different DL TEIDs.

Although not illustrated fully in FIGS. 5A and 5B to avoid clutter, example procedures for indicating interest in MBS are briefly considered next.

A UE that is receiving or interested in receiving an MBS can transmit an MBS interest indication to a network (e.g., to a CN 110). Based on the MBS interest indication, the network attempts to enable the UE to receive MBS and unicast services subject to the capabilities of the UE, e.g., the radio capabilities of the UE. In the MBS interest indication, the UE can indicate a set of frequencies (including one or more frequencies) where the UE is receiving or is interested in receiving MBS. The MBS interest indication can also indicate a list of MBS services that the UE is receiving or is interested in receiving on the indicated one or more frequencies. Further, the UE can transmit the MBS interest indication regardless of whether the serving cell supports MBS. In some cases, the UE can send a first MBS interest indication to the network, and send a second, updated MBS interest indication at a later time.

Generally speaking, a UE and/or a RAN manage information related to multicast and/or broadcast services (MBS). In response to determining that a radio connection between the UE and the RAN is to be modified, the UE can determine to either retain or release an MBS interest indication. If the UE retains the MBS interest indication, the UE can later transmit an MBS interest indication update to the RAN. If the UE releases the MBS interest indication, the UE may transmit another MBS interest indication to the RAN after modifying the radio connection.

Likewise, a node of the RAN can also receive an MBS interest indication from the UE, and either retain or release the configuration included in the MBS interest indication in response to determining that a radio connection between the UE and the RAN is to be modified. Trigger events that can cause the UE and/or the RAN to determine to release or retain the MBS interest indication include the UE detecting a failure on the radio connection, or the UE suspending, resuming, or reestablishing the radio connection with the RAN.

Further, MBS interest indications can be stored at the receiving RAN node, at other RAN nodes, and/or at one or more CNs of the wireless communication system. For example, the RAN node receiving an MBS interest indication from a UE can forward the received UE MBS interest indication to another RAN node, to the CN, etc., any of which can forward the UE MBS interest indication to other RAN nodes and/or CNs.

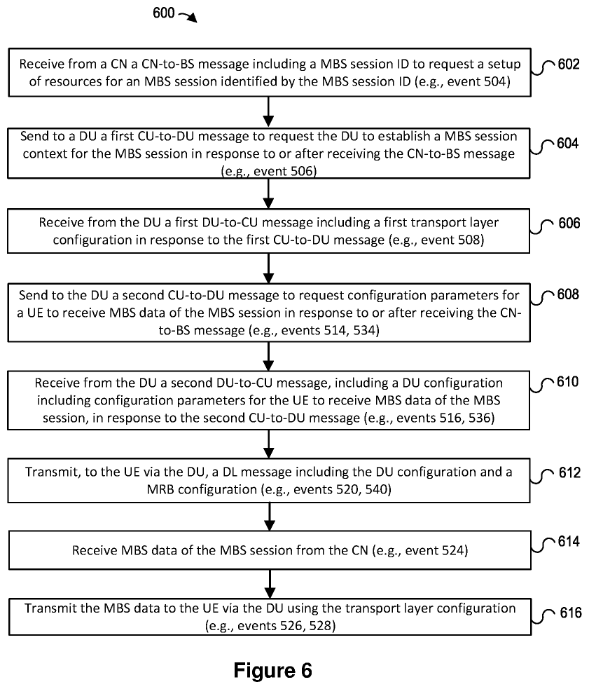

Next, several example methods for configuring and utilizing resources to facilitate MBS communications are discussed with reference to FIGS. 6-20. Methods in a CU can be implemented in the CU 172, and methods in a DU can be implemented in the DU 174, for example. These methods can be implemented as sets of instructions stored on a non-transitory computer-readable medium and executable by processing hardware, such as one or more CPUs for example.

Referring first to FIG. 6, an example method 600 for configuring a CN-to-BS tunnel and a transport layer of the CU-to-DU link can be implemented in a CU, for example. The CU can execute this method to configure CU-to-DU communications for a certain MBS session, when the CU receives a request from the CN and does not yet have the necessary configuration for the MBS session on the CU-to-DU interface.

The method 600 begins at block 602, where the CU receives a CN-to-BS message that requests that the CU set up an MBS session for a certain MBS session ID (e.g., event 504). Next, at block 604, the CU transmits a CU-to-DU message requesting that the DU establish an MBS session context for the MBS session (e.g., event 506). This CU-to-DU message can be referred to as the first CU-to-DU message. The CU can execute block 604 directly in response to, or subsequently to, receiving the CN-to-BS message at block 602.

At block 606, and in response to the first CU-to-DU message, the CU receives a (first) DU-to-CU message that includes a (first) transport-layer configuration (e.g., event 508). Then, at block 608, the CU transmits to the DU a (second) CU-to-DU message to request configuration parameters for a UE that operates in a cell of the DU and that indicated interest in the MBS session and/or joined the MBS session (e.g., events 514, 534). In response, at block 610, the CU can receive from the DU a (second) DU-to-CU message. This message can include a DU configuration that the UE can apply to receive MBS data of the MBS session (e.g., events 516, 536). At block 612, the CU transmits the DU configuration and an MRB configuration to the UE via the DU (e.g., events 520, 540).

At block 614, the CU receives MBS data associated with the MBS session from the CN (e.g., event 524). The CU then transmits, at block 616, the MBS data to the UE via the DU in accordance with the transport-layer configuration of the CU-to-DU link received at block 606.

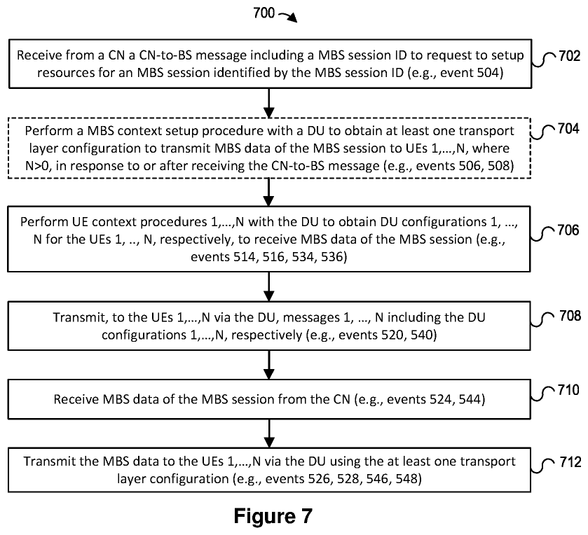

Now referring to FIG. 7, a method 700 is also for configuring an MBS session at a CU, but here the CU performs a UE context procedure for multiple UEs. At block 702, the CU receives a CN-to-BS message that requests that the CU set up an MBS session for a certain MBS session ID (e.g., event 504).

At block 704, the CU performs an MBS context setup procedure with a DU to obtain at least one transport layer configuration to transmit MBS data of the MBS session to UEs 1, . . . , N, where N>0, in response to or after receiving the CN-to-BS message (e.g., events 506, 508). However, in some implementations, the CU can obtain the at least one transport layer configuration during the UE context procedure discussed below, in which case the CU does not need to perform the MBS context setup procedure at block 704.

Next, at block 706, the CU performs UE context procedures 1, . . . , N with the DU to obtain DU configurations 1, . . . , N for the UEs 1, . . . , N, respectively (e.g., events 514, 516, 534, 536). The UEs use the corresponding DU configurations to receive MBS data of the MBS session.

In some implementations, the CU connects to the UEs 1, . . . , N as well as to UEs (N+1), . . . , Z, where Z>N>0, and/or stores UE contexts 1, . . . , Z of the UEs 1, . . . , Z. The CU determines that only the UEs 1, . . . , N joined the MBS session, and that the UEs (N+1), . . . , Z did not join the MBS session. In such scenarios, the CN-to-BS message may include MBS session information indicating the UEs 1, . . . , N joined the MBS session and (explicitly or implicitly) that the UEs (N+1), . . . , Z did not join the MBS session. In other scenarios, rather than receiving a list of UEs, the CU receives from the CN a separate CN-to-BS message for each of the UEs 1, . . . , N, where each CN-to-BS message indicates that a certain UE joined the MBS session.

At block 708, the CU transmits the corresponding DU configurations to the UEs 1, . . . , N via the DU (e.g., event 520, 540). At block 710, the CU receives MBS data associated with the MBS session from the CN (e.g., event 524, 544). The CU then transmits, at block 712, the MBS data to the UEs 1, . . . , N, in accordance with the at least one transport-layer configuration (e.g., events 526, 528, 546, 548). More particularly, the CU can generate and transmit transport layer data packets such as PDCP PDUs.

Further, when the base station includes multiple DUs, the CU can execute blocks 704-712 for another (second DU) to transmit the MBS data to UEs 1, . . . , P, where P>0.

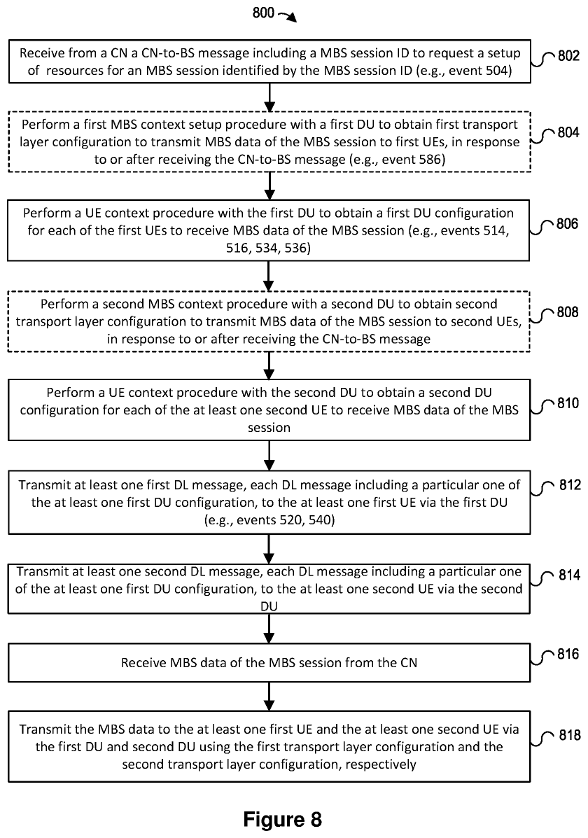

Next, FIG. 8 illustrates another method 800 for configuring an MBS session at a CU. The CU can execute this method to configure multiple CU-to-DU links for the respective DUs connected to the CU, where different sets of UEs are in communication with the corresponding DUs (e.g., a first set of UEs communicates with the CU via a first DU, and a second set of UEs communicates with the CU via a second DU). In the discussion of FIG. 8 below, transport-layer configuration relates to the CU-to-DU link (rather than the CN-to-BS link or the radio interface, for example).

At block 802, the CU receives, from the CN, a CN-to-BS message including an MBS session ID to request that the CU set up resources for an MBS session (e.g., event 504). The method 800 optionally includes block 804, where the CU performs a (first) MBS context setup procedure with a first DU to obtain first transport layer configuration, so that the CU can transmit MBS data to UEs in a first set (e.g., event 586). At block 806, the CU performs a UE context procedure with the first DU to obtain a first DU configuration for each UE in in the first set (e.g., events 514, 516, 534, 536). At optional block 808, the CU performs a second MBS context procedure with a second DU to obtain second transport-layer configuration, so that the CU can transmit MBS data of the MBS session to UEs in a second set. Then, at block 810, the CU performs a UE context procedure with the second DU to obtain a second DU configuration for each UE in in the second set.

At block 812, the CU transmits at least one first DL message, each DL message including a particular one of the at least one first DU configurations, to the at least one UE in the first set, via the first DU (e.g., events 520, 540). At block 814, the CU transmits at least one second DL message, each DL message including a particular one of the at least one second DU configurations, to the at least one UE in the second set, via the second DU. Next, at block 816, the CU receives MBS data of the MBS session from the CN. At block 818, the CU transmits the MBS data to the at least one UE in the first set and the at least one UE in the second via the first DU and second DU, respectively. To this end, the CU uses the first transport layer configuration and the second transport layer configuration, respectively.

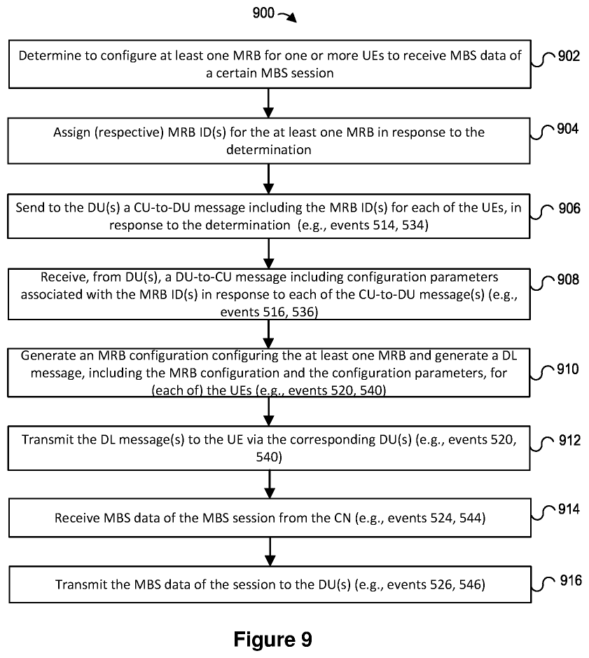

Now referring to FIG. 9, a CU can implement a method 900 to configure an MRB session and provide a shared or common MRB configuration to multiple UEs.

At block 902, the CU determines to configure at least one MRB for one or more UEs, via which the UEs will receive MBS data of a certain MBS session. At block 904, the CU can assign an MRB ID to the MRB. When the CU configures multiple MRBs, the CU assigns different MRB IDs to the corresponding MRBs. Next, at block 906, the CU can send to the DU a CU-to-DU message that includes the MRB ID(s) for each of the UEs (e.g., events 514, 534). When the CU is connected to multiple DUs, the CU can send separate CU-to-DU messages to each of the DUs.

At block 908, the CU can receive, from the DU, a DU-to-CU message including configuration parameters associated with the MRB ID(s), in response to the corresponding CU-to-DU message (e.g., events 516, 536). Then, at block 910, the CU can generate an MRB configuration for the at least one MRB (e.g., events 520, 540). The CU also can generate a DL message, including the MRB configuration and the configuration parameters, for each of the UEs. At block 912, the CU transmits the DL message(s) to the UE via the corresponding DU(s) (e.g., events 520, 540). At block 914, the CU receives MBS data of the MBS session from the CN (e.g., events 524, 544) and, at block 916, the CU transmits the MBS data of the MBS session to the one or more DUs (e.g., events 526, 546).

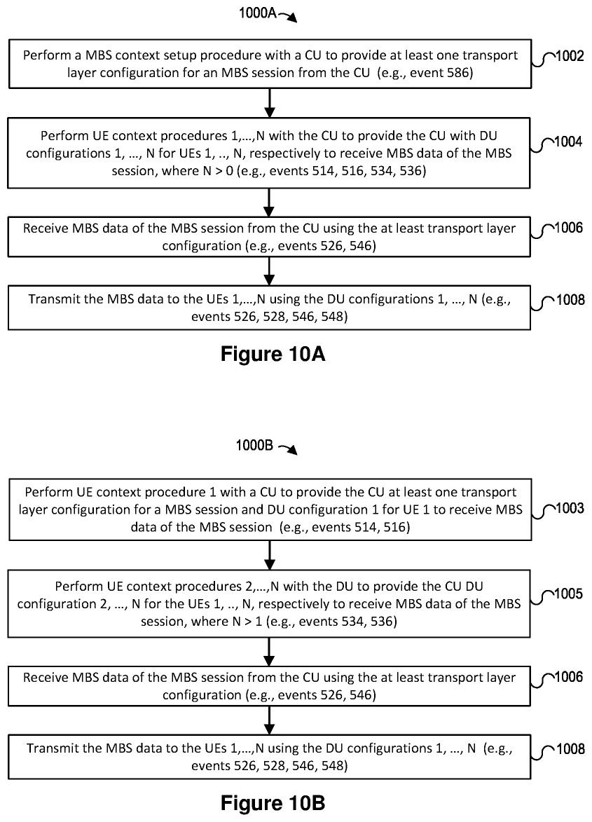

Next, FIG. 10A illustrates an example method 1000A in a DU for configuring a transport layer of the CU-to-DU link for receiving MBS data from a CU, and generating DU configurations for UEs.

At block 1002, the DU performs an MBS context setup procedure with a CU to provide at least one transport layer configuration for an MBS session from the CU (e.g., event 586). At block 1004, the DU performs UE context procedures 1, . . . , N with the CU to provide the CU with DU configurations 1, . . . , N for UEs 1, . . . , N, respectively, so that the UEs can receive MBS data of the MBS session, where N>0 (e.g., events 514, 516, 534, 536). At block 1006, the DU can receive MBS data of the MBS session from the CU using the at least transport layer configuration (e.g., events 526, 546). At block 1008, the DU transmits the MBS data to the UEs 1, . . . , N using the DU configurations 1, . . . , N (e.g., events 526, 528, 546, 548).

FIG. 10B illustrates a generally similar method 100B, but with the DU providing transport-layer configuration to the CU during the first UE context procedure, rather than separately and subsequently to establishing an MBS context.

In particular, at block 1003, the DU performs UE context procedure 1 with a CU to provide the CU at least one transport layer configuration for an MBS session, and DU configuration 1 for UE 1 to receive MBS data of the MBS session (e.g., events 514, 516). At block 1005, the DU performs UE context procedures 2, . . . , N with the DU to provide the CU with DU configurations 2, . . . , N for the UEs 1 . . . , N, respectively, where N>1 (e.g., events 534, 536). The flow then proceeds to blocks 1006 and 1008 discussed above.

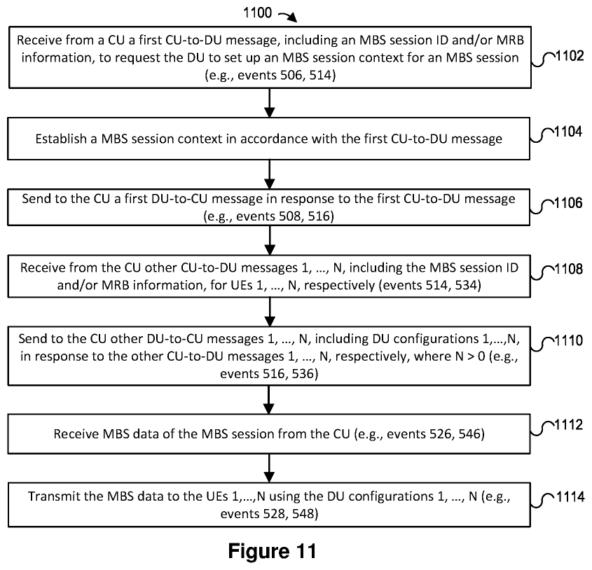

FIG. 11 is a flow diagram of another method 1100 at a DU for configuring an MBS session. The method 1100 includes multiple instances of a UE context setup procedure and multiple transmissions of the radio interface configuration to respective UEs.

In particular, at block 1102, the DU receives from a CU a first CU-to-DU message including an MBS session ID and/or MRB information (e.g., events 506, 514). The first CU-to-DU message requests that the DU set up an MBS session context for an MBS session. In some implementations, the MRB information may include MRB ID(s) with different values. For each of the MRB ID(s), the DU can assign a particular logical channel ID in the logical channel ID(s). For each of the MRB ID(s), the DU can generate a particular transport layer configuration. Each of the transport layer configuration(s) can include a transport layer address and/or a DL tunnel ID. The transport layer configurations are different. In some implementations, the DU can include the transport layer configuration(s) in the first DU-to-CU message and/or the other DU-to-CU message(s). The DU can receive MBS data of the MBS session from the CU in accordance with the transport layer configuration(s).

At block 1104, the DU establishes an MBS session context in accordance with the first CU-to-DU message. At block 1106, the DU transmits to the CU a first DU-to-CU message, in response to the first CU-to-DU message (e.g., events 508, 516). At block 1108, the DU receives from the CU other CU-to-DU messages 1, . . . , N, including the MBS session ID and/or MRB information, for UEs 1, . . . , N, respectively (e.g., events 514, 534).

At block 1110, the DU transmits to the CU other DU-to-CU messages 1, . . . , N, including DU configurations 1, . . . , N, in response to the other CU-to-DU messages 1, . . . , N, respectively, where N>0 (e.g., events 516, 536). In some implementations, the DU includes logical channel ID(s), each identifying a logical channel, in each of the DU configurations 1, . . . , N. Next, at block 112, the DU receives MBS data of the MBS session from the CU (e.g., events 526, 546). At block 114, the DU transmits the MBS data to the UEs 1, . . . , N using the DU configurations 1, . . . , N (e.g., events 528, 548).

Referring to FIG. 12, a DU can implement a method 1200 to configure a DL tunnel on a CU-to-DU interface and a logical channel on a radio interface, for an MBS session.

The method 1200 begins at block 1202, where the DU performs a procedure with a CU to set up at least one DL tunnel for one or more MBS sessions and assign at least one DL tunnel ID associated with the at least one DL tunnel (e.g., events 506, 508, 514, 516). At block 1204, the DU configures at least one logical channel (ID) associated with the at least one DL tunnel (ID). At block 1206, the DU transmits DU configuration(s), each configuring the at least one logical channel (ID), to UE(s) (e.g., events 516, 518, 520, 536, 538, 540). Next, at block 1208, the DU receives MBS data of the MBS session(s) from the CU via the at least one DL tunnel (e.g., events 526, 546). At block 1210, the DU transmits the MBS data to the UE(s) via the at least one logical channel tunnel (events 528, 548).

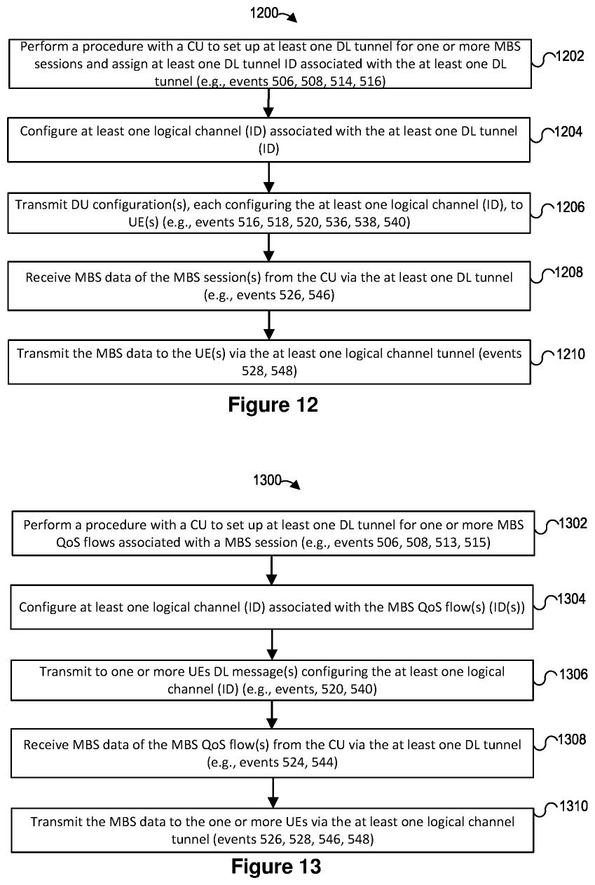

FIG. 13 illustrates a method 1300 for configuring an MBS session at a DU, where the setup includes configuring one or more QoS flows on a CU-to-DU interface and one or more corresponding logical channels on a radio interface, for the MBS session.

More specifically, at block 1302, the DU performs a procedure with a CU to set up at least one DL tunnel for one or more MBS QoS flows associated with an MBS session (e.g., events 506, 508, 513, 515). At block 1304, the DU configures at least one logical channel (ID) associated with the MBS QoS flow(s) (ID(s)). At block 1306, the DU transmits, to one or more UEs, DL message(s) configuring the at least one logical channel (ID) (e.g., events, 520, 540). At block 1308, the DU receives MBS data of the MBS QoS flow(s) from the CU via the at least one DL tunnel (e.g., events 524, 544). At block 1310, the DU transmits the MBS data to the one or more UEs via the at least one logical channel tunnel (events 526, 528, 546, 548).

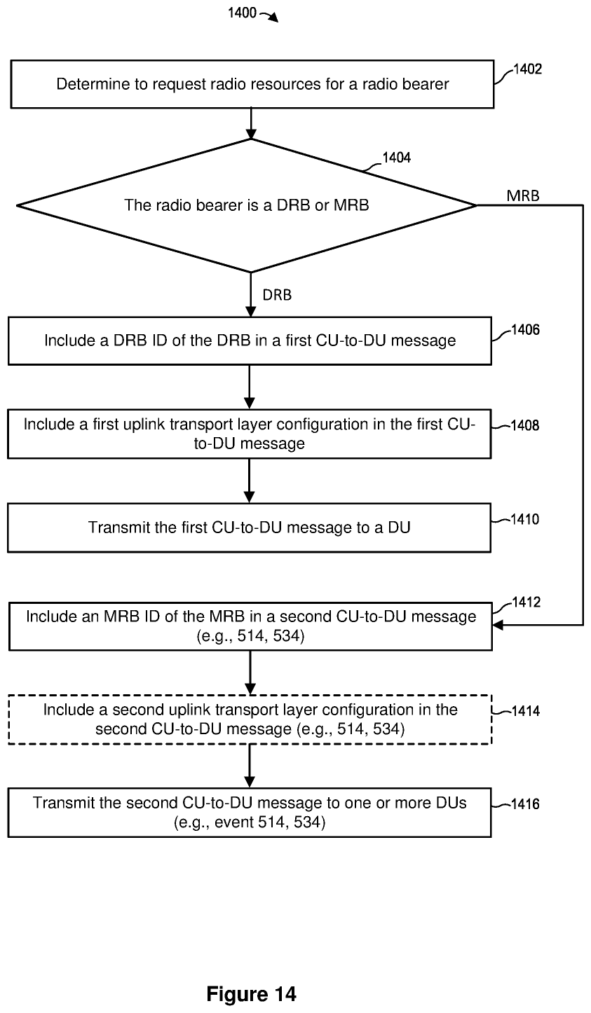

Now referring to FIG. 14, the CU in some cases can generate an uplink transport-layer configuration for DU-to-CU link differently depending on whether the radio bearer is a DRB or an MRB.

A method 1400 begins a block 1402, where the CU determines to request radio resources for a radio bearer. At block 1404, the CU determines whether the radio bearer is a DRB or an MRB. When the CU determines that the radio bearer is a DRB, the flow proceeds to block 1406, where the CU includes a DRB ID of the DRB in a first CU-to-DU message. At block 1408, the CU includes a first uplink transport layer configuration in the first CU-to-DU message. At block 1410, the CU transmits the first CU-to-DU message to a DU. However, if the CU determines at block 1404 that the radio bearer is an MRB, the flow proceeds to block 1412, where the CU includes an MRB ID of the MRB in a second CU-to-DU message (e.g., 514, 534). The flow the proceeds to optional block 1414, where the CU can include a second uplink transport layer configuration in the second CU-to-DU message (e.g., 514, 534), and then to block 1416, where the CU transmits the second CU-to-DU message to one or more DUs (e.g., event 514, 534).

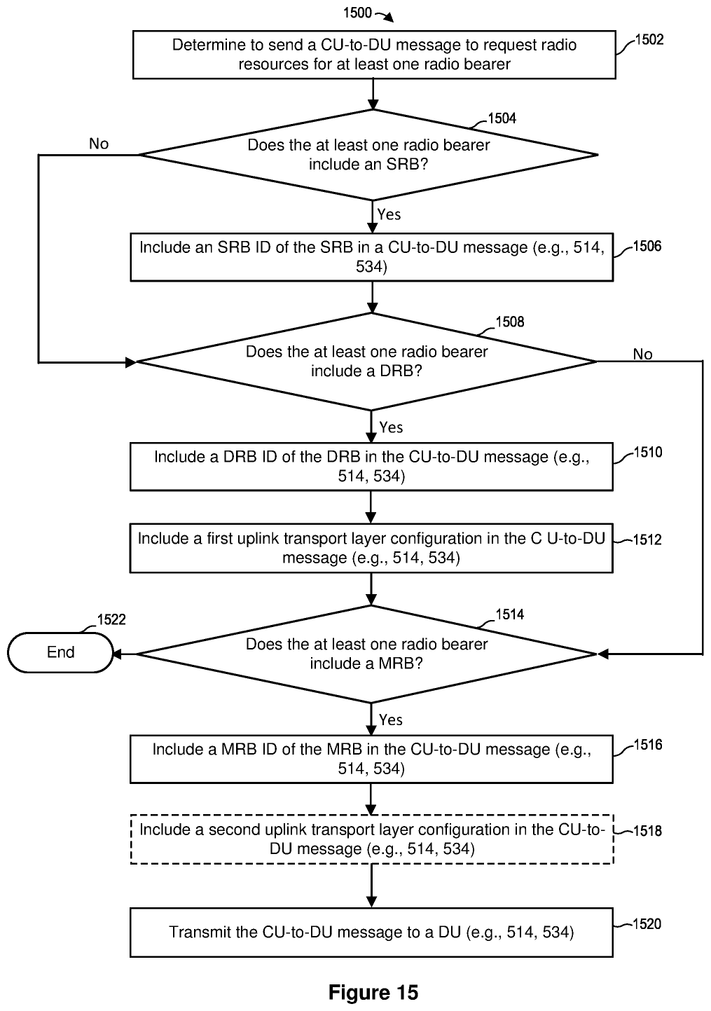

As illustrated next in FIG. 15, a CU also can implement 1500 to determine whether to include an identity of one or more of an SRB, a DRB, or an MRB in a CU-to-DU message requesting radio resources for an MBS session or another data session. This method begins at block 1502, where the CU determines to send a CU-to-DU message to request radio resources for at least one radio bearer. At block 1504, the CU determines whether the at least one radio bearer includes an SRB. If so, the CU at block 1506 includes an SRB ID of the SRB in a CU-to-DU message (e.g., 514, 534). Otherwise, the flow proceeds directly from block 1504 to block 1508.

At block 1508, the CU determines whether the at least one radio bearer includes a DRB. If so, the CU at block 1510 includes a DRB ID of the DRB in a CU-to-DU message (e.g., 514, 534) and, at block 1512, the CU includes a first uplink transport layer configuration in the CU-to-DU message (e.g., 514, 534). Otherwise, the flow proceeds directly from block 1508 to block 1514.

At block 1514, the CU determines whether the at least one radio bearer includes an MRB. If so, the CU at block 1516 includes an MRB ID of the MRB in the CU-to-DU message (e.g., 514, 534); the method 1500 otherwise completes (block 1522). Optionally, at block 1518, the CU includes a second uplink transport layer configuration in the CU-to-DU message (e.g., 514, 534). At block 1520, the CU transmits the CU-to-DU message to a DU (e.g., 514, 534).

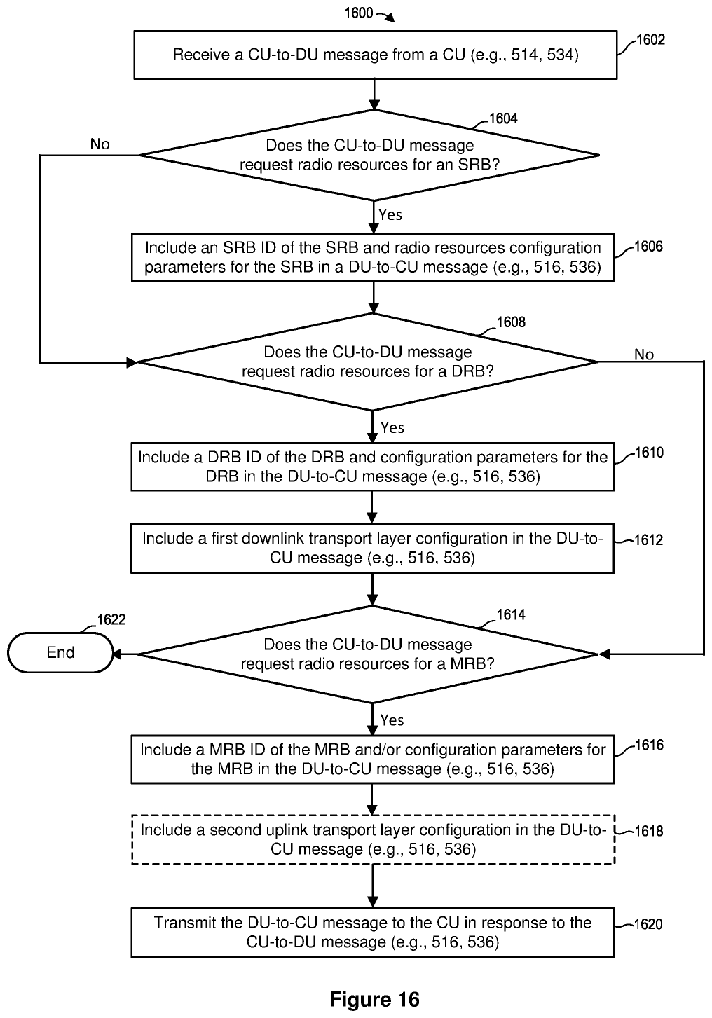

FIG. 16 illustrates an example method 1600 for determining, at a DU, whether the CU requested one or more of an SRB, a DRB, or an MRB for an MBS session or another data session. The DU can execute the method 1600 in response to the CU executing the method 1500 discussed above with reference to FIG. 15.

At block 1602, the DU receives a CU-to-DU message from a CU (e.g., 514, 534). At block 1604, the DU determines whether the CU-to-DU message requested radio resources for an SRB. If so, the flow proceeds to block 1606, where the DU includes an SRB ID of the SRB and radio resources configuration parameters for the SRB in a DU-to-CU message (e.g., 516, 536). Otherwise, the flow proceeds to block 1608, where the DU determines whether the CU-to-DU message requested radio resources for a DRB. If so, the flow proceeds to block 1610 and then to block 1612. At block 1610, the DU includes a DRB ID of the DRB and configuration parameters for the DRB in the DU-to-CU message (e.g., 516, 536). At block 1612, the DU includes a first downlink transport layer configuration in the DU-to-CU message (e.g., 516, 536).

At block 1614, the DU determines whether the CU-to-DU message requested radio resources for an MRB. The method 1600 completes if the CU-to-DU message did not request radio resources for an MRB. Otherwise, the flow proceeds to block 1616, where the DU includes an MRB ID of the MRB and/or configuration parameters for the MRB in the DU-to-CU message (e.g., 516, 536). At optional block 1618, the DU includes a second uplink transport layer configuration in the DU-to-CU message (e.g., 516, 536). At block 1620, the DU transmits the DU-to-CU message to the CU in response to the CU-to-DU message (e.g., 516, 536).

Referring generally to the method 1600, the DU in some implementations generates the configuration parameters for the SRB, DRB, and/or MRB. The configuration parameters for the SRB include a first RLC bearer configuration (e.g., RLC-BearerConfig IE) and a SRB configuration (e.g., SRB-ToAddMod IE). The first RLC bearer configuration can include the SRB ID and a first logical channel ID identifying a first logical channel. The configuration parameters for the DRB include a second RLC bearer configuration (e.g., RLC-BearerConfig IE) and a DRB configuration (e.g., DRB-ToAddMod IE). The second RLC bearer configuration can include the DRB ID and a second logical channel ID identifying a second logical channel. The configuration parameters for the MRB include a third RLC bearer configuration (e.g., RLC-BearerConfig IE) and a MRB configuration (e.g., MRB-ToAddMod IE). The third bearer RLC configuration can include the MRB ID and a third logical channel ID identifying a third logical channel. In addition to the third RLC bearer configuration, the configuration parameters can include a fourth RLC bearer configuration (e.g., RLC-BearerConfig IE), in some implementations. In such cases, the fourth RLC bearer configuration can include the MRB ID and a fourth logical channel ID identifying a fourth logical channel. In some implementations, the DU assigns different values to the logical channel IDs.

Each of the RLC bearer configuration(s) can include RLC configuration parameters for operating a RLC entity, such as RLC mode (e.g., acknowledged mode or unacknowledged mode), RLC sequence number length, and/or timer value(s).

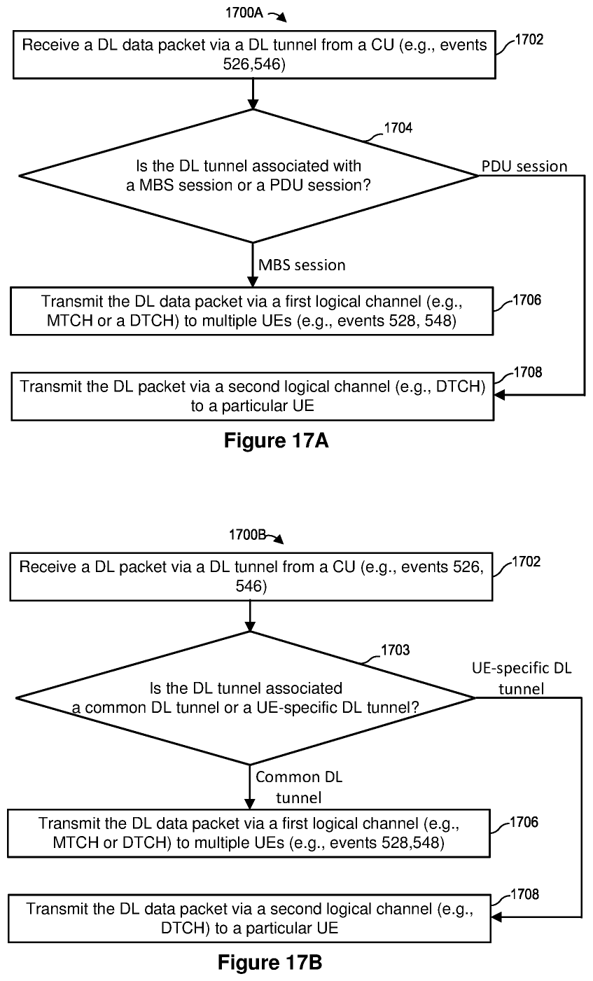

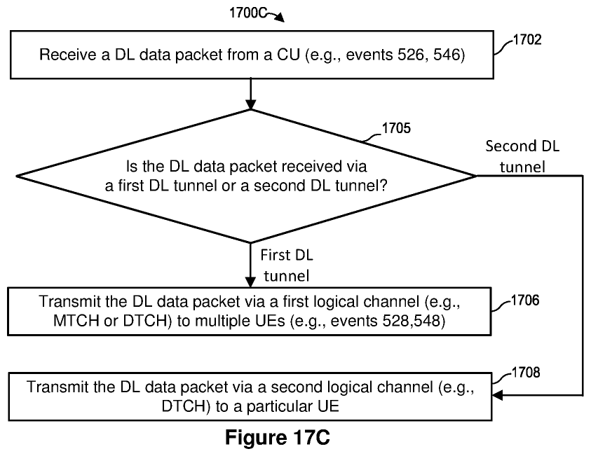

Now referring to FIG. 17A, a DU can implement a method 1700A to determine which logical channel the DU should use to transmit a data packet, based on whether the DL tunnel via which the data packet arrived is associated with an MBS session or a UE-specific PDU session.

At block 1702, the DU receives a DL data packet via a DL tunnel from a CU (e.g., events 526, 546). If, at block 1704, the DU determines that the DL tunnel is associated with an MBS session, the flow proceeds to block 1706; otherwise, the flow proceeds to block 1708. At block 1706, the DU transmits the DL data packet via a first logical channel (e.g., MTCH or a DTCH) to multiple UEs (e.g., events 528, 548), and the method 1700 completes. Otherwise, at block 1708, the DU transmits the DL packet via a second logical channel (e.g., DTCH) to a particular UE.

As an alternative to the method 1700A, or in addition to the method 1700A, the DU can implement a method 1700B. According to this method, the DU at block 1703 determines which logical channel the DU should use to transmit a data packet depending on whether the DL tunnel via which the data packet arrived is a common DL tunnel or a UE-specific DL tunnel. The flow proceeds to block 1706 discussed above, when the DL tunnel is a common DL tunnel, and to block 1708 when the DL tunnel is a UE-specific DL tunnel. In some implementations, the DU implements both the decision of block 1704 and the decision of block 1703 so that, for example, the flow proceeds to block 1706 when the session is an MBS session and the tunnel is a common DL tunnel.

Referring to FIGS. 17A and 17B, the DU in some cases assigns a first LCID and a second LCID to identify the first LC and second LC, respectively. To transmit the DL data packet via the first LC, the DU generates DL MAC PDU(s) including the first LCID and the DL data packet and transmits (i.e., multicast or unicast) the DL MAC PDU(s) to the multiple UEs. To transmit the DL data packet via the second LC, the DU generates DL MAC PDU(s) including the second LCID and the DL data packet and transmits (i.e., unicast) to the particular UE. The DU transmits DL messages (e.g., 1, . . . , N) including the first LCID to the multiple UEs (e.g., 1, . . . , N), respectively. The DU transmits a DL message including the second LCID to the particular UE.

As another alternative to the method 1700A, or in addition to the methods 1700A and/or 1700B, the DU can implement a method 1700C as shown in FIG. 17C. According to this method, the DU at block 1705 determines whether the DL data packet was received via a first DL tunnel or a second DL tunnel. The flow proceeds to block 1706 discussed above, when the DL tunnel is a first DL tunnel, and to block 1708 when the DL tunnel is a second DL tunnel.

In some implementations, the DU assigns a first transport layer configuration and a second transport layer configuration to identify the first DL tunnel and second DL tunnel, respectively. The first transport layer configuration includes a first transport layer address and a first TEID, and the second transport layer configuration include a second transport layer address and a second TEID. At least one of the first transport layer address (value) and the first TEID (value) is different from the at least one of the second transport layer address (value) and the second TEID (value). The DU receives a DL tunnel packet including a transport layer address, a TEID and the DL data packet. If the transport layer address and the TEID are the first transport layer address and the first DL TEID respectively, the DU determines the DL data packet is received via the first DL tunnel. If the transport layer address and the TEID are the second transport layer address and the second DL TEID respectively, the DU determines the DL data packet is received via the second DL tunnel.

In some implementations, the DU assigns a first LCID and a second LCID to identify the first LC and second LC. The DU can associate the first LCID and the second LCID to the first transport layer configuration and the second transport layer configuration, respectively. To transmit the DL data packet via the first LC, the DU generates DL MAC PDU(s) including the first LCID and the DL data packet and transmits (i.e., multicast or unicast) the DL MAC PDU(s) to the multiple UEs. To transmit the DL data packet via the second LC, the DU generates DL MAC PDU(s) including the second LCID and the DL data packet and transmits (i.e., unicast) to the particular UE. The DU transmits DL messages (e.g., 1, . . . , N) including the first LCID to the multiple UEs (e.g., 1, . . . , N), respectively. The DU transmits a DL message including the second LCID to the particular UE.

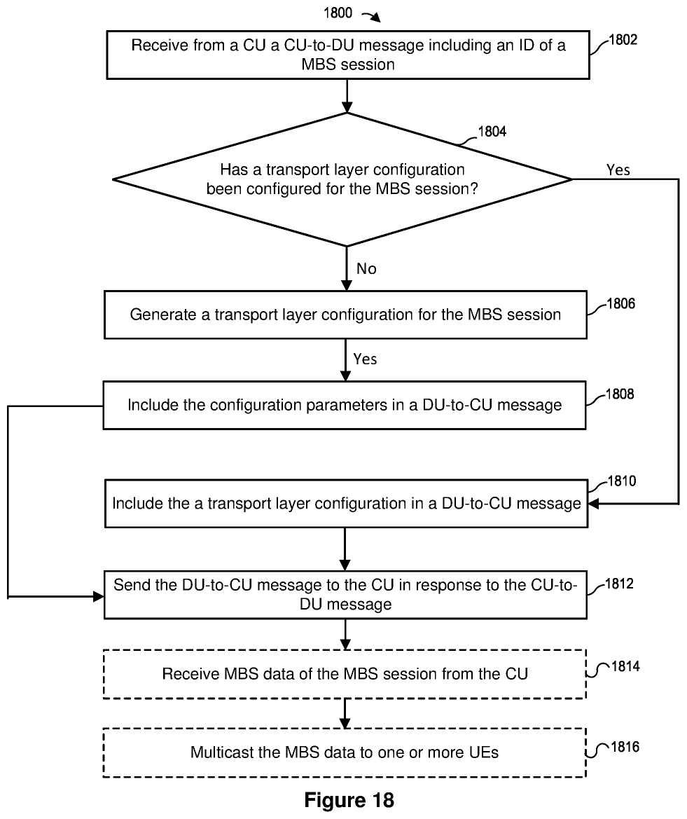

FIG. 18 is a flow diagram of an example method 1800 in a DU for determining whether the DU should generate a transport layer configuration for an MBS session or include a previously generated transport configuration in a message to a CU.

At block 1802, the DU receives from a CU a CU-to-DU message including an ID of an MBS session. At block 1804, the DU determines whether it already has a transport layer configuration for the MBS session. If so, the flow proceeds to block 1810. Otherwise, the DU generates a transport layer configuration for the MBS session at block 1806, includes the corresponding configuration parameters in a DU-to-CU message at block 1808, and proceeds to block 1812, where the DU transmits the DU-to-CU message to the CU. At block 1814, the DU can receive MBS data of the MBS session from the CU, and multicast the MBS data to one or more UEs at block 1816.

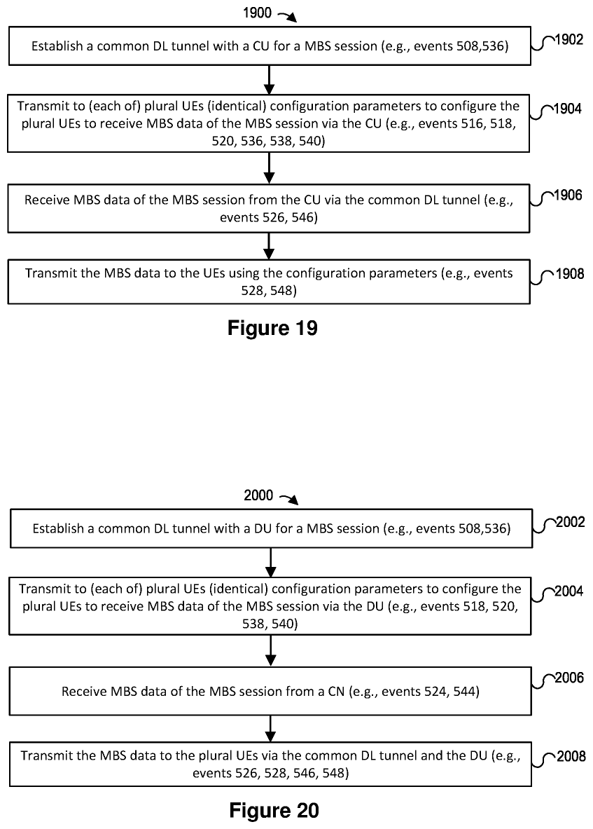

Referring next to FIG. 19, a DU can implement an example method 1900 to manage MBS transmissions. At block 1902, the DU establishes a common DL tunnel with a CU for an MBS session (e.g., events 508, 536). At block 1904, the DU transmits to (each of) plural UEs (identical) configuration parameters to configure the plural UEs to receive MBS data of the MBS session via the CU (e.g., events 516, 518, 520, 536, 538, 540). At block 1906, the DU receives MBS data of the MBS session from the CU via the common DL tunnel (e.g., events 526, 546). At block 1908, the DU transmits the MBS data to the UEs using the configuration parameters (e.g., events 528, 548).

Finally, FIG. 20 illustrates example method 2000 for managing MBS transmissions, which can be implemented in a CU. At block 2002, the CU establishes a common DL tunnel with a DU for an MBS session (e.g., events 508, 536). At block 2004, the CU transmits to (each of) plural UEs (identical) configuration parameters to configure the plural UEs to receive MBS data of the MBS session via the DU (e.g., events 518, 520, 538, 540). At block 2006, the CU receives MBS data of the MBS session from a CN (e.g., events 524, 544). At block 2008, the CU transmits the MBS data to the plural UEs via the common DL tunnel and the DU (e.g., events 526, 528, 546, 548).

The following list of examples reflects a variety of the embodiments explicitly contemplated by the present disclosure:

Example 1. A method for managing transmission of multicast and/or broadcast services (MBS) data, implemented in a central unit (CU) of a distributed base station that includes the CU and a distributed unit (DU), the method comprising: receiving, by processing hardware from a core network (CN), a request to configure CN-to-BS resources for transmitting downlink (DL) MBS data associated with an MBS session, from the CN for multiple user equipment units (UEs) via the distributed base station; obtaining, by the processing hardware, a configuration for a downlink (DL) tunnel for transmitting the DL MBS data from the CU to the DU; and communicating, by the processing hardware, the DL MBS data between the CN and the DU using the CN-to-BS resources and the configuration for the DL tunnel.

Example 2. The method of example 1, wherein: the obtaining includes configuring the DL tunnel as a common DL tunnel via which the CU is configured to transmit, to two or more of the multiple UEs via the DU, a common data packet included in the DL MBS data.

Example 3. The method of example 2, wherein: the DU is one of a plurality of DUs included in the distributed base station; and the obtaining includes configuring a respective common DL tunnel for each of the plurality of DUs.

Example 4. The of example 2, wherein configuring the DL tunnel includes: transmitting, to the DU, a CU-to-DU message including a session identifier for the MBS session; and receiving, in response to the CU-to-DU message, a DU-to-CU message including transport-layer configuration for the common DL tunnel.

Example 5. The method of example 4, wherein the transport-layer configuration for the common DL tunnel includes at least one of: an Internet Protocol (IP) address or a Tunnel Endpoint Identifier (TEID).

Example 6. The method of any of the preceding examples, further comprising: transmitting, by the processing hardware to the DU, a request for radio resources for transmitting the DL MBS data to the DU; receiving, by the processing hardware from the DU and in response to the request, a DU configuration including at least one logical channel associated with a radio interface of the DU.

Example 7. The method of example 6, wherein transmitting the request for radio resources includes transmitting a request for context of one of the multiple UEs.

Example 8. The method of example 7, further comprising transmitting, in respective multiple instances, the request for radio resources for each of the multiple UEs.

Example 9. The method of example 6, further comprising: transmitting, via the DU to the multiple UEs, the DU configuration.

Example 10. The method of example 9, wherein transmitting the DU configuration includes: transmitting, to each of the multiple UEs, a respective reconfiguration command associated with a protocol for controlling radio resources.

Example 11. The method of any of examples 6-10, further comprising: determining, by the processing hardware, a multicast radio bearer (MRB) in which the at least one logical channel is included; and transmitting, by the processing hardware to the DU, an indication that the MRB corresponds to the MBS session.

Example 12. The method of any of examples 1-10, further comprising: generating, by the processing hardware, a configuration for an uplink (UL) tunnel for the MBS session; and transmitting, by the processing hardware, the configuration for the UL tunnel to the DU.

Example 13. The method of example 12, wherein generating the configuration for the UL tunnel includes: in response to determining that a radio bearer that corresponds to the MBS session is an MRB, configuring the UL tunnel as a common UL tunnel for use by the multiple UEs.

Example 14. The method of example 12, wherein generating the configuration for the UL tunnel includes: in response to determining that a radio bearer that corresponds to the MBS session is a data radio bearer (DRB), configuring the UL tunnel as a UE-specific UL tunnel, for one of the multiple UEs.

Example 15. The method of any of examples 1-10, further comprising: in response to determining that a radio bearer that corresponds to the MBS session is an MRB, refraining from configuring a UL tunnel for the MBS session.

Example 16. The method of any of the preceding examples, further comprising: receiving, from the CN and subsequently to the request to configure the CN-to-BS resources, a list specifying the multiple UEs joining the MBS session.

Example 17. The method of any of examples 1-15, further comprising: receiving, from the CN and prior the request to configure the CN-to-BS resources, a list specifying the multiple UEs joining the MBS session.

Example 18. The method of any of the preceding examples, further comprising: receiving, by the processing hardware from the CN, a quality of service (QOS) configuration for the MBS session; and transmitting, by the processing hardware to the DU, the QoS configuration.

Example 19. The method of example 18, wherein receiving the QoS configuration includes receiving a configuration for a plurality of QoS flows.

Example 20. A method for managing transmission of multicast and/or broadcast services (MBS) data, implemented in a DU of a distributed base station that includes a CU and the DU, the method comprising: receiving, by processing hardware from the CU, a request for a configuration of a DL tunnel for receiving MBS data from the CU associated with an MBS session, for multiple UEs; and transmitting, by the processing hardware to the CU, the configuration of the DL tunnel; receiving, by the processing hardware, the DL MBS data from the CU via the DL tunnel; and transmitting, by the processing hardware via a radio interface, the DL MBS data to the multiple UEs.

Example 21. The method of example 20, wherein: configuring the DL tunnel as a common DL tunnel via which the DU is configured to receive a data packet associated with the MBS session and transmit the data packet to the multiple UEs via a radio interface.

Example 22. The of example 21, wherein configuring the DL tunnel includes: receiving, from the CU, a CU-to-DU message including a session identifier for the MBS session; and transmitting, in response to the CU-to-DU message, a DU-to-CU message including transport-layer configuration for the common DL tunnel.

Example 23. The method of example 22, wherein the transport-layer configuration for the common DL tunnel includes at least one of an Internet Protocol (IP) address and a Tunnel Endpoint Identifier (TEID).

Example 24. The method of any of examples 20-23, further comprising: receiving, by the processing hardware from the CU, a request for radio resources for the MBS session; allocating, by the processing hardware, at least one logical channel associated with a radio interface of the DU; transmitting, by the processing hardware to the CU and in response to the request, a DU configuration including the at least one logical channel.

Example 25. The method of example 24, wherein receiving the request for radio resources includes receiving a request for context of one of the multiple UEs.

Example 26. The method of example 25, further comprising receiving, in a respective multiple instances, the request for radio resources for each of the multiple UEs.

Example 27. The method of any of examples 24-26, further comprising: receiving, by the processing hardware from the CU, an indication of an MRB that corresponds to the MBS session and includes the at least one logical channel.

Example 28. The method of any of examples 24-27, further comprising: transmitting an indication of the at least one logical channel to each of the multiple UEs.

Example 29. The method of any of examples 24-28, wherein the at least one logical channel is a multicast traffic channel (MTCH).

Example 30. The method of any of examples 20-29, wherein: receiving the DL MBS data from the CU via the DL tunnel includes receiving a data packet; determining, by the processing hardware, to transmit the data packet to the multiple UEs in response to determining that the DL tunnel is associated with the MBS session.

Example 31. The method of any of examples 20-29, wherein: receiving the DL MBS data from the CU via the DL tunnel includes receiving a data packet; determining, by the processing hardware, to transmit the data packet to the multiple UEs in response to determining that the DL tunnel is a common tunnel configured for more than UE.

Example 32. A network node comprising processing hardware and configured to implement a method according to any of the preceding examples.

The following additional considerations apply to the foregoing discussion.

In some implementations, “message” is used and can be replaced by “information element (IE)”. In some implementations, “IE” is used and can be replaced by “field”. In some implementations, “configuration” can be replaced by “configurations” or the configuration parameters. In some implementations, “MBS” can be replaced by “multicast” or “broadcast”.

A user device in which the techniques of this disclosure can be implemented (e.g., the UE 102A or 102B) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for communicating MBS information through the disclosed principles herein. Thus, while particular embodiments and applications have been illustrated and described, it is to be understood that the disclosed embodiments are not limited to the precise construction and components disclosed herein.

1. A method for managing transmission of multicast and/or broadcast services (MBS) data, implemented in a central unit (CU) of a distributed base station that includes the CU and a distributed unit (DU), the method comprising:
receiving, by the CU from a core network (CN), a request to configure CN-to-BS resources for transmitting downlink (DL) MBS data associated with an MBS session, from the CN for multiple user equipment units (UEs) via the distributed base station;
transmitting, by the CU to the DU, a first CU-to-DU message requesting that the DU establish an MBS session context for the MBS session;
receiving, by the CU from the DU a configuration for a downlink (DL) tunnel for transmitting the DL MBS data from the CU to the DU;
transmitting, by the CU to the DU, a second CU-to-DU message requesting radio resources for transmitting the DL MBS data from the DU to a UE of the multiple UEs;
receiving, by the CU from the DU, in response to the second CU-to-DU message, a DU configuration that the UE of the multiple UEs can utilize to communicate the DL MBS data with the DU; and
communicating, by the CU, the DL MBS data between the CN and the DU using the CN-to-BS resources and the configuration for the DL tunnel.

2. The method of claim 1, wherein the DU configuration includes at least one logical channel associated with a radio interface of the DU.

3. The method of claim 2, further comprising:
determining, by the processing hardware, a multicast radio bearer (MRB) in which the at least one logical channel is included; and
transmitting, by the processing hardware to the DU, an indication that the MRB corresponds to the MBS session.

4. The method of claim 1, wherein transmitting the second CU-to-DU message includes transmitting a request for context of one of the multiple UEs.

5. The method of claim 4, further comprising transmitting, in respective multiple instances, the request for context for each of the multiple UEs.

6. The method of claim 4, wherein transmitting the request for context includes transmitting at least one of a UE Context Setup Request message or a UE Context Modification Request message.

7. The method of claim 1, further comprising:
transmitting, via the DU to the multiple UEs, the DU configuration.

8. The method of claim 7, wherein transmitting the DU configuration includes:
transmitting, to each of the multiple UEs, a respective reconfiguration command associated with a protocol for controlling radio resources.

9. The method of claim 1, further comprising:
generating, by the processing hardware, a configuration for an uplink (UL) tunnel for the MBS session; and
transmitting, by the processing hardware, the configuration for the UL tunnel to the DU.

10. A method for managing transmission of multicast and/or broadcast services (MBS) data, implemented in a distributed unit (DU) of a distributed base station that includes a central unit (CU) and the DU, the method comprising:
receiving, by the DU from the CU, a first CU-to-DU message requesting that the DU establish an MBS session context for an MBS session, the MBS session for communicating downlink (DL) MBS data to multiple user equipment units (UEs); and
transmitting, by the DU to the CU a configuration of a DL tunnel for receiving the DL MBS data at the DU from the CU;
receiving, by the DU from the CU, a second CU-to-DU message requesting radio resources for transmitting the DL MBS data from the DU to a UE of the multiple UEs;
transmitting, by the DU to the CU, a DU configuration that the UE of the multiple UEs can utilize to communicate the DL MBS data with the DU;
receiving, by the DU, the DL MBS data from the CU via the DL tunnel; and
transmitting, by the DU, the DL MBS data to the multiple UEs.

11. The method of claim 10, further comprising:
allocating, by the processing hardware, at least one logical channel associated with a radio interface of the DU;
including, in the DU configuration, the at least one logical channel.

12. The method of claim 10, wherein receiving the second CU-to-DU message includes receiving a request for context of one of the multiple UEs.

13. The method of claim 12, further comprising receiving, in a respective multiple instances, the request for context for each of the multiple UEs.

14. The method of claim 12, wherein receiving the request for context includes receiving at least one of a UE Context Setup Request message or a UE Context Modification Request message.

15. A network node, operating as a central unit (CU) of a distributed base station that includes the CU and a distributed unit (DU), configured to manage transmission of multicast and/or broadcast services (MBS) data, the network node comprising:
a transceiver; and
processing hardware configured to:
receive, from a core network (CN), a request to configure CN-to-BS resources for transmitting downlink (DL) MBS data associated with an MBS session, from the CN for multiple user equipment units (UEs) via the distributed base station;
transmit, to the DU, a first CU-to-DU message requesting that the DU establish an MBS session context for the MBS session;
receive, from the DU a configuration for a downlink (DL) tunnel for transmitting the DL MBS data from the CU to the DU;
transmit, to the DU, a second CU-to-DU message requesting radio resources for transmitting the DL MBS data from the DU to a UE of the multiple UEs;
receive, from the DU, in response to the second CU-to-DU message, a DU configuration that the UE of the multiple UEs can utilize to communicate the DL MBS data with the DU; and
communicate the DL MBS data between the CN and the DU using the CN-to-BS resources and the configuration for the DL tunnel.

16. The network node of claim 15, wherein the DU configuration includes at least one logical channel associated with a radio interface of the DU.

17. The network node of claim 16, wherein the processing hardware is further configured to:
determine a multicast radio bearer (MRB) in which the at least one logical channel is included; and
transmit, to the DU, an indication that the MRB corresponds to the MBS session.

18. The network node of claim 15, wherein transmitting the second CU-to-DU message includes:
transmitting a request for context of one of the multiple UEs.

19. The network node of claim 18, wherein the processing hardware is further configured to:
transmit, in respective multiple instances, the request for context for each of the multiple UEs.

20. The network node of claim 18, wherein transmitting the request for context includes:
transmitting at least one of a UE Context Setup Request message or a UE Context Modification Request message.
